(19) United States
(12) Patent Application Publication
(10) Pub. No.: US 2024/0193530 A1
(43) Pub. Date: Jun. 13, 2024

(54) DELIVERY MANAGEMENT DEVICE, DELIVERY SYSTEM, DELIVERY MANAGEMENT METHOD, AND STORAGE MEDIUM STORING DELIVERY MANAGEMENT PROGRAM

(71) Applicant: Mitsubishi Electric Corporation, Tokyo (JP)

(72) Inventors: Ryuhei TAKAHASHI, Tokyo (JP); Yoshie IMAI, Tokyo (JP); Nobuaki MOTOYAMA, Tokyo (JP); Kentaro ISHIKAWA, Tokyo (JP); Shunya OSAWA, Tokyo (JP); Satoru FURUTA, Tokyo (JP)

(73) Assignee: Mitsubishi Electric Corporation, Tokyo (JP)

(21) Appl. No.: 18/582,056

(22) Filed: Feb. 20, 2024

Related U.S. Application Data
(63) Continuation of application No. PCT/JP2021/034330, filed on Sep. 17, 2021.

(51) Int. Cl. G06Q 10/083; B60W 60/00; H04W 4/029

(52) U.S. Cl. CPC G06Q 10/083; B60W 60/00256; H04W 4/029

(57) ABSTRACT

Upon receiving a request for delivering a parcel stored in a locked storage space to a user, a delivery management device makes a responsible vehicle move to a user present position, receives a key entrustment completion notification from the responsible vehicle, receives a pickup completion notification, and receives a delivery & key return completion notification. Alternatively, upon receiving a request for delivering a parcel picked up from the user to the storage space, the delivery management device makes the responsible vehicle move to the user present position, receives a key entrustment completion notification and a pickup completion notification, makes the responsible vehicle move to the storage space, receives a delivery completion notification and a completion notification of locking by using the key, makes the responsible vehicle move to the user present position again, and receives a key return completion notification from the responsible vehicle.

### CROSS-REFERENCE TO RELATED APPLICATION

This application is a continuation application of International Application No. PCT/JP2021/034330 having an international filing date of Sep. 17, 2021.

### BACKGROUND OF THE INVENTION

### 1. Field of the Invention

The present disclosure relates to a delivery management device, a delivery system, a delivery management method, and a delivery management program.

### 2. Description of the Related Art

There has been proposed a delivery system including vehicles that carry parcels and a management server that communicates with the vehicles (see Patent Reference 1, for example). The management server transmits a command to a vehicle so that the vehicle arrives at a designated delivery destination at a set time. A user receives the parcel from the vehicle at the designated delivery destination at the set time.

Patent Reference 1 is Japanese Patent Application Publication No. 2019-101463 (see paragraphs 0030 and 0031, FIG. 1 and FIG. 2, for example).

However, in the delivery system described above, there is a problem in that it is impossible to deliver a parcel to the inside of a storage space (e.g., a user's automobile) as the delivery destination and lock the storage space or to unlock a locked storage space as a delivery source and deliver a parcel taken out from the storage space.

### SUMMARY OF THE INVENTION

An object of the present disclosure is to provide a delivery management device, a delivery system, a delivery management method and a delivery management program that enable delivery of a parcel by use of a lockable storage space.

A delivery management device in the present disclosure includes processing circuitry to execute communication with a plurality of vehicles each of which autonomously travels in a previously set area and to output vehicle position information indicating a vehicle present position; and to issue commands to the plurality of vehicles based on map information indicating a map of the area, vehicle information indicating types of the plurality of vehicles, user information that includes information regarding a user terminal outputting user position information indicating a user present position and information regarding a user, and storage space information including a position of a storage space that can be used by the user, wherein upon receiving a delivery request for delivering a first parcel stored in the storage space locked to the user, the processing circuitry selects one vehicle among the plurality of vehicles as a responsible vehicle based on one or more items of information out of contents of the delivery request, the map information, the vehicle information, the user information and the storage space information and makes the responsible vehicle move to the user present position while keeping track of the user in real time, receives a key entrustment completion notification, indicating that a key of the storage space has been entrusted to the responsible vehicle, from the responsible vehicle, makes the responsible vehicle move to the storage space and receives a pickup completion notification, indicating that the first parcel stored in the storage space unlocked by using the key has been loaded onto the responsible vehicle, from the responsible vehicle, and makes the responsible vehicle move to the user present position again and receives a delivery & key return completion notification, indicating that the first parcel and the key have been taken out from the responsible vehicle, from the responsible vehicle.

Another delivery management device in the present disclosure includes processing circuitry to execute communication with a plurality of vehicles each of which autonomously travels in a previously set area and to output vehicle position information indicating a vehicle present position; and to issue commands to the plurality of vehicles based on map information indicating a map of the area, vehicle information indicating types of the plurality of vehicles, user information that includes information regarding a user terminal outputting user position information indicating a user present position and information regarding a user, and storage space information including a position of a storage space that can be used by the user, wherein upon receiving a delivery request for delivering a second parcel picked up from the user to the storage space, the processing circuitry selects one vehicle among the plurality of vehicles as a responsible vehicle based on one or more items of information out of contents of the delivery request, the map information, the vehicle information, the user information and the storage space information and makes the responsible vehicle move to the user present position while keeping track of the user in real time, receives a key entrustment completion notification indicating that a key of the storage space has been entrusted to the responsible vehicle and a pickup completion notification indicating that the second parcel has been loaded onto the responsible vehicle from the responsible vehicle, makes the responsible vehicle move to the storage space and receives a delivery completion notification indicating that the second parcel has been stored in the storage space and a locking completion notification indicating that the storage space has been locked by using the key, and makes the responsible vehicle move to the user present position again and receives a key return completion notification, indicating that the key has been returned to the user, from the responsible vehicle.

According to the present disclosure, it is possible to deliver a parcel by use of a lockable storage space.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram schematically showing the configuration of a delivery system according to an embodiment;

FIG. 2 is a diagram schematically showing a commercial facility in an area shown in FIG. 1;

FIG. 3 is a functional block diagram schematically showing the configuration of a management server in FIG. 1;

FIG. 4 is a diagram showing an example of the hardware configuration of the management server in FIG. 3;

FIG. 5 is a functional block diagram schematically showing the configuration of a vehicle in FIG. 1;

FIG. 6 is a diagram showing an example of the hardware configuration of the vehicle in FIG. 5;

FIG. 7 is a functional block diagram schematically showing the configuration of a user terminal in FIG. 1;

FIG. 8 is a diagram showing an example of the hardware configuration of the user terminal in FIG. 7;

FIG. 9 is a functional block diagram schematically showing the configuration of a shop terminal in FIG. 1;

FIG. 10 is a diagram showing an example of the hardware configuration of the shop terminal in FIG. 9;

FIG. 11 is a functional block diagram schematically showing the configuration of a hotel terminal in FIG. 1;

FIG. 12 is a diagram showing an example of the hardware configuration of the hotel terminal in FIG. 11;

FIGS. 13A to 13F are schematic diagrams for explaining a first operation example of the delivery system according to the embodiment;

FIG. 14 is a sequence diagram showing the operation of the user terminal, the vehicle, and the management server in the first operation example;

FIG. 15 is a flowchart showing the operation of the management server in the first operation example;

FIGS. 16A to 16E are schematic diagrams for explaining a second operation example of the delivery system according to the embodiment;

FIG. 17 is a sequence diagram showing the operation of the user terminal, the vehicle, and the management server in the second operation example;

FIG. 18 is a flowchart showing the operation of the management server in the second operation example;

FIGS. 19A to 19E are schematic diagrams for explaining a third operation example of the delivery system according to the embodiment;

FIG. 20 is a sequence diagram showing the operation of the user terminal, the vehicle, and the management server in the third operation example;

FIG. 21 is a flowchart showing the operation of the management server in the third operation example;

FIGS. 22A to 22F are schematic diagrams for explaining a fourth operation example of the delivery system according to the embodiment;

FIG. 23 is a sequence diagram showing the operation of the user terminal, the vehicle, and the management server in the fourth operation example;

FIG. 24 is a flowchart showing the operation of the management server in the fourth operation example;

FIGS. 25A to 25E are schematic diagrams for explaining a fifth operation example of the delivery system according to the embodiment;

FIG. 26 is a sequence diagram showing the operation of the user terminal, the vehicle, and the management server in the fifth operation example;

FIG. 27 is a flowchart showing the operation of the management server in the fifth operation example;

FIGS. 28A to 28F are schematic diagrams for explaining a sixth operation example of the delivery system according to the embodiment;

FIG. 29 is a sequence diagram showing the operation of the user terminal, the vehicle, and the management server in the sixth operation example;

FIG. 30 is a flowchart showing the operation of the management server in the sixth operation example;

FIGS. 31A to 31G are schematic diagrams for explaining a seventh operation example of the delivery system according to the embodiment;

FIG. 32 is a sequence diagram showing the operation of the user terminal, the vehicle, and the management server in the seventh operation example;

FIG. 33 is a flowchart showing the operation of the management server in the seventh operation example;

FIGS. 34A to 34G are schematic diagrams for explaining an eighth operation example of the delivery system according to the embodiment;

FIG. 35 is a sequence diagram showing the operation of the user terminal, the vehicle, and the management server in the eighth operation example; and

FIG. 36 is a flowchart showing the operation of the management server in the eighth operation example.

### DETAILED DESCRIPTION OF THE INVENTION

A delivery management device, a delivery system, a delivery management method, and a delivery management program according to an embodiment will be described below with reference to the drawings. The following embodiments are just examples and it is possible to appropriately combine embodiments and appropriately modify each embodiment.

### (Delivery System)

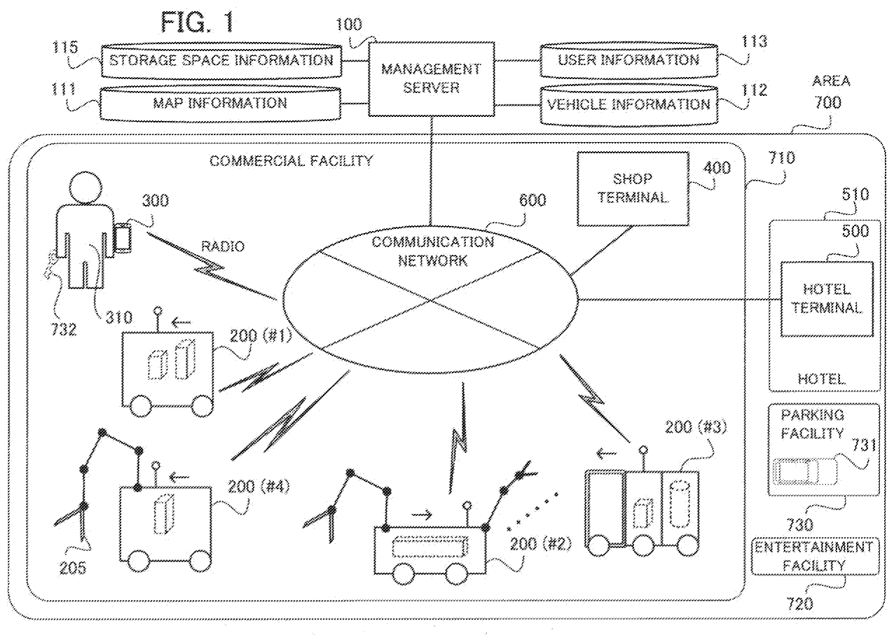

FIG. 1 is a diagram schematically showing the configuration of a delivery system according to the embodiment. As shown in FIG. 1, the delivery system according to the embodiment includes a management server 100 as a delivery management device and a plurality of vehicles 200 as a plurality of autonomous traveling vehicles that autonomously travel in a previously set area 700. The management server 100 is a device capable of executing a delivery management method according to the embodiment. The management server 100 is a computer, for example. The management server 100 is capable of executing a delivery management program according to the embodiment.

In the example of FIG. 1, facilities are provided in the area 700. In the example of FIG. 1, a commercial facility 710, an entertainment facility 720, a parking facility 730, and a hotel 510 as an accommodation facility are provided in the area 700. However, facilities in the area 700 are not limited to the illustrated facilities. A Japanese-style inn, a cloakroom and a coin-operated locker can be taken as other examples of the facility.

FIG. 2 is a diagram schematically showing the commercial facility 710 in the area 700 shown in FIG. 1. FIG. 1 and FIG. 2 illustrate a user 310 using the commercial facility 710, a user terminal 300 carried by the user 310 such as a smartphone, a shop terminal 400 provided in a shop (e.g., register), and a plurality of vehicles 200 (#1, #2, #3, #4). The plurality of vehicles 200 are desired to include a plurality of types of vehicles differing in the type (e.g., capacity of a storage compartment, capacity of a rechargeable battery supplying electric power for the traveling, presence/absence of a vehicle arm unit 205, or the like). However, the number of users 310, the number of user terminals 300, the number of shop terminals 400, and the number and types of vehicles 200 are not limited to those shown in FIG. 1 and FIG. 2.

The management server 100 is capable of accessing map information 111 indicating a map of the area 700, vehicle information 112 indicating the types (including structure, performance, etc.) of the plurality of vehicles 200, user information 113, and storage space information 115. The user information 113 includes information regarding the user terminal 300 outputting user position information U indicating a user present position (e.g., information identifying the user terminal 300) and information regarding the user 310 (e.g., information identifying the user). The information regarding the user 310 can include, for example, personal information on the user 310 (e.g., attribute information) and information regarding a family accompanying the user 310. The user information 113 includes, for example, information that has previously been registered for a trip using the hotel 510. The storage space information 115 is information regarding a parking position and the type of an automobile 731 (e.g., automobile 731 owned by the user 310) as the storage space that can be used by the user (e.g., user 310), a parcel storage position in the automobile 731, and so forth. The user 310 carries a key 732 for locking and unlocking the automobile 731. The map information 111, the vehicle information 112, the user information 113 and the storage space information 115 are acquired from a storage device of the management server 100 or an external storage device. The external storage device can be a storage device of another server connected to a communication network 600.

The management server 100, the plurality of vehicles 200 and one or more user terminals 300 are capable of communicating with each other via the communication network 600, for example. Further, one or more shop terminals 400 and terminals of other facilities (e.g., hotel terminal 500 provided in the hotel 510), in addition to the management server 100, the plurality of vehicles 200 and one or more user terminals 300, may be capable of communicating with each other via the communication network 600. The management server 100 issues commands to the plurality of vehicles 200 based on the map information 111, the vehicle information 112, the user position information U and the storage space information 115. For example, as shown in FIG. 2, the plurality of vehicles 200 may be moving in the commercial facility 710 according to previously set schedules and previously set travel routes.

When a request for the delivery of a parcel is received, the management server 100 acquires vehicle position information V from the vehicles 200, acquires the user position information U from the user terminal 300, selects (determines) one vehicle among the plurality of vehicles 200 based on one or more items of information out of the contents of the delivery request, the map information 111, the vehicle information 112, the user information 113 and the storage space information 115, and makes the selected vehicle 200 as a responsible vehicle 210 move to the user present position. Thus, the management server 100 can receive the delivery request as a request with no designation of a rendezvous spot of the user 310 (i.e., a place where the parcel, the key, etc. should be handed over between the responsible vehicle 210 and the user 310). Further, the management server 100 can receive the delivery request as a request with no designation of a rendezvous time of the user 310 (i.e., a time when the parcel, the key, etc. should be handed over between the responsible vehicle 210 and the user 310) or with designation of a time with a certain time span (i.e., designation of an approximate time). The determination of the responsible vehicle 210 may be made in consideration of the remaining battery charge of the rechargeable battery of each vehicle at the time of the determination and road conditions between each vehicle 200 and the user position (e.g., being under repair, being bumpy, etc.).

### (Management Server 100)

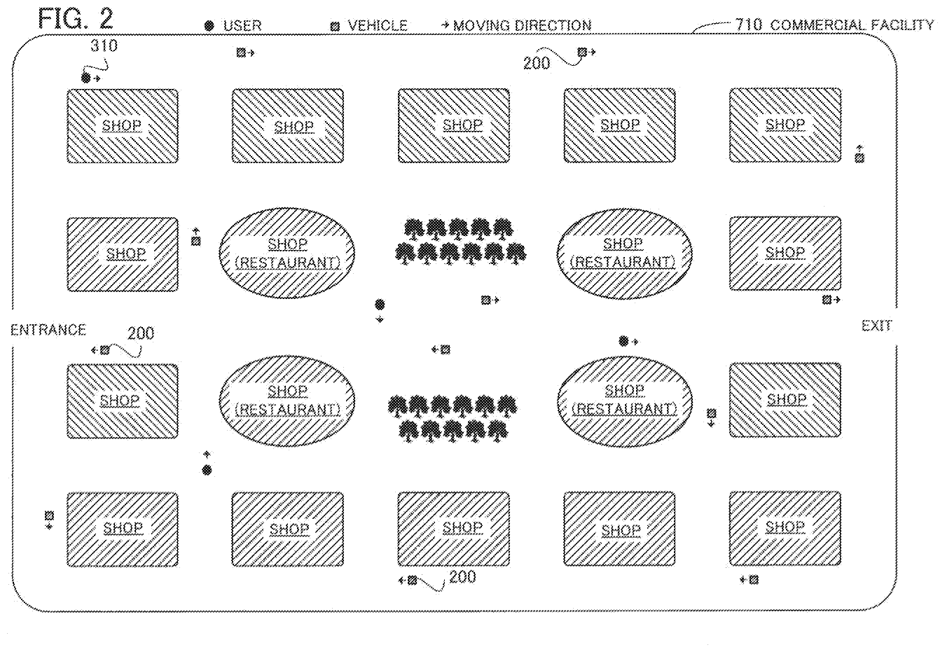

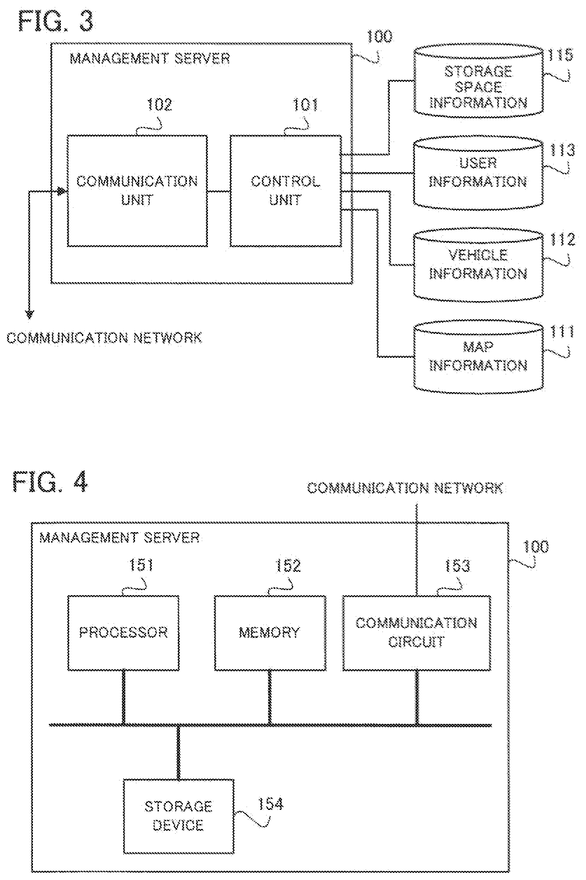

FIG. 3 is a functional block diagram schematically showing the configuration of the management server 100 in FIG. 1. As shown in FIG. 3, the management server 100 includes a communication unit 102 that executes communication with the plurality of vehicles 200 via the communication network 600 and a control unit 101 that acquires the map information 111, the vehicle information 112, the user information 113 and the storage space information 115 and issues commands regarding the traveling of the plurality of vehicles 200, a command for accessing the inside of the automobile 731 as the storage space, and so forth based on the acquired information.

The management server 100 includes the communication unit 102 that executes communication with the plurality of vehicles 200 each of which autonomously travels in a predetermined area and outputs the vehicle position information indicating a vehicle present position and the control unit 101 that issues commands to the plurality of vehicles 200 based on the map information 111 indicating the map of the area, the vehicle information 112 indicating the types of the plurality of vehicles (i.e., autonomous traveling vehicles), the user information 113 that includes the information regarding the user terminal outputting the user position information indicating the user present position and the information regarding the user, and the storage space information 115 including the position of the storage space that can be used by the user. The map information 111, the vehicle information 112, the user information 113 and the storage space information 115 can also be not information from the storage device but information acquired via the communication unit 102.

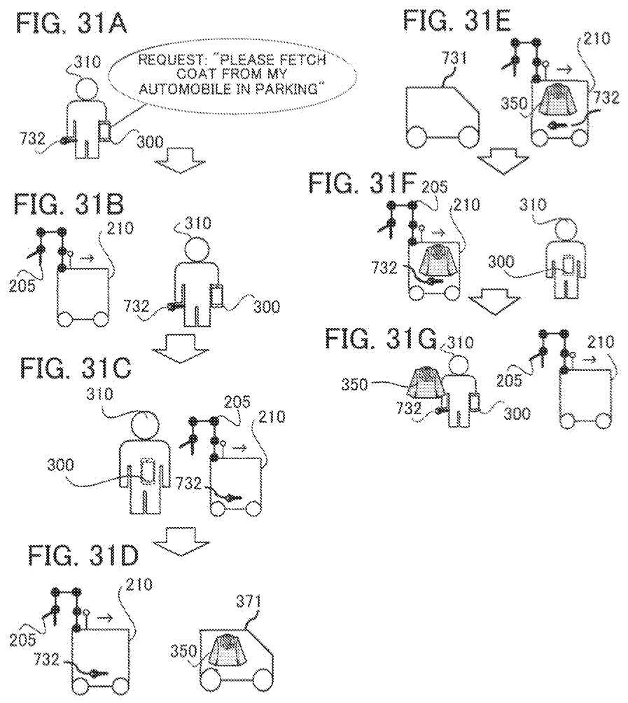

Upon receiving a delivery request (i.e., parcel reception request) for delivering a first parcel (i.e., reception parcel) stored in a locked storage space (e.g., the automobile 731 in FIG. 1) to a user (e.g., the user 310), the control unit 101 executes a control operation for selecting one vehicle among the plurality of vehicles as the responsible vehicle 210 based on one or more items of information out of the contents of the delivery request, the map information 111, the vehicle information 112, the user information 113 and the storage space information 115, making the responsible vehicle 210 move to the user present position while keeping track of the user in real time, receiving a key entrustment completion notification, indicating that the key of the storage space (e.g., the key 732 of the automobile 731) has been entrusted to the responsible vehicle 210, from the responsible vehicle 210, making the responsible vehicle 210 move to the storage space (e.g., the automobile 731), receiving a pickup completion notification indicating that the first parcel stored in the storage space unlocked by using the key has been loaded onto the responsible vehicle 210 (e.g., stored in the storage compartment of the responsible vehicle 210) from the responsible vehicle 210, making the responsible vehicle 210 move to the user present position again, and receiving a delivery & key return completion notification, indicating that the first parcel and the key (e.g., the key 732) have been taken out from the responsible vehicle 210, from the responsible vehicle 210. An example of the operation when the user 310 has made the parcel reception request will be described later as a seventh operation example with reference to FIG. 31 to FIG. 33.

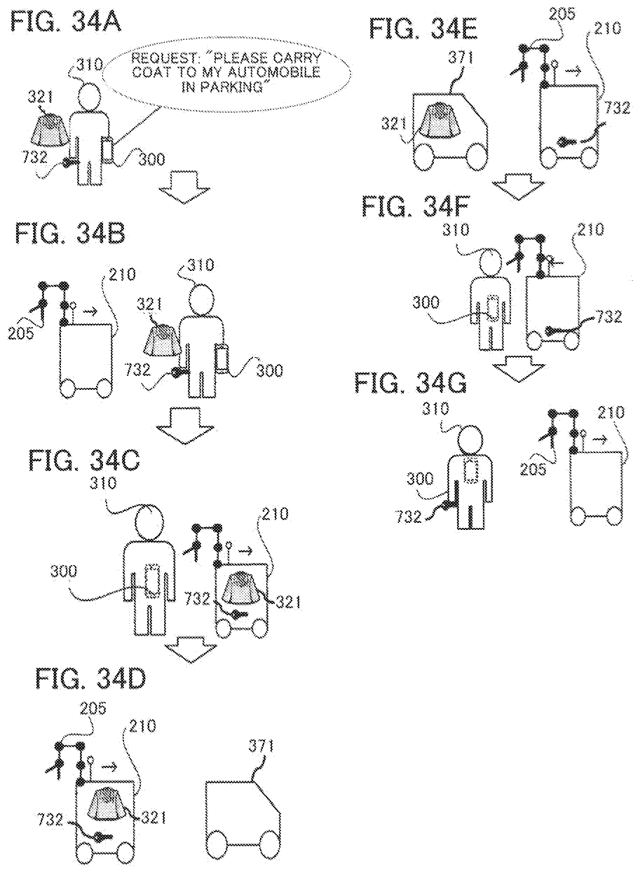

In addition to or instead of the above-described control when the parcel reception request is received, upon receiving a delivery request (i.e., parcel shipment request) for delivering a second parcel picked up from a user (i.e., shipment parcel) to a storage space (e.g., the automobile 731 in FIG. 1), the control unit 101 may execute a control operation for selecting one vehicle among the plurality of vehicles as the responsible vehicle 210 based on one or more items of information out of the contents of the delivery request, the map information 111, the vehicle information 112, the user information 113 and the storage space information 115, making the responsible vehicle 210 move to the user present position while keeping track of the user (e.g., the user 310) in real time, receiving the key entrustment completion notification indicating that the key of the storage space (e.g., the key 732 of the automobile 731) has been entrusted to the responsible vehicle 210 and the pickup completion notification indicating that the second parcel has been loaded into the responsible vehicle 210 from the responsible vehicle 210, making the responsible vehicle 210 move to the storage space, receiving a delivery completion notification indicating that the second parcel has been stored in the storage space and a locking completion notification indicating that the storage space has been locked by using the key, making the responsible vehicle 210 move to the user present position again, and receiving a key return completion notification, indicating that the key has been returned to the user, from the responsible vehicle 210. An example of the operation when the user 310 has made the parcel shipment request will be described later as an eighth operation example with reference to FIG. 34 to FIG. 36.

FIG. 4 is a diagram showing an example of the hardware configuration of the management server 100 in FIG. 3. As shown in FIG. 4, the management server 100 includes a processor 151 such as a CPU (Central Processing Unit), a memory 152 as a volatile storage device, a communication circuit 153 that executes the communication, and a nonvolatile storage device 154 such as a hard disk drive (HDD) or a solid state drive (SSD). The memory 152 is a semiconductor memory such as a RAM (Random Access Memory), for example.

Functions of the management server 100 are implemented by processing circuitry. The processing circuitry can be either dedicated hardware or the processor 151 executing a program stored in the memory 152. The processor 151 can be any one of a processing device, an arithmetic device, a microprocessor, a microcomputer and a DSP (Digital Signal Processor).

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In the case where the processing circuitry is the processor 151, the delivery management program is implemented by software, firmware, or a combination of software and firmware. The software and the firmware are described as programs and stored in the memory 152. The processor 151 implements the functions of the units shown in FIG. 3 by reading out and executing the delivery management program stored in the memory 152. The memory 152 and the storage device 154 may be a non-transitory computer-readable storage medium, i.e., a non-transitory tangible storage medium storing a program such as the delivery management program.

Incidentally, it is also possible to implement part of the management server 100 by dedicated hardware and part of the management server 100 by software or firmware. As above, the processing circuitry is capable of implementing the above-described functions by hardware, software, firmware or a combination of some of these means.

### (Vehicle 200)

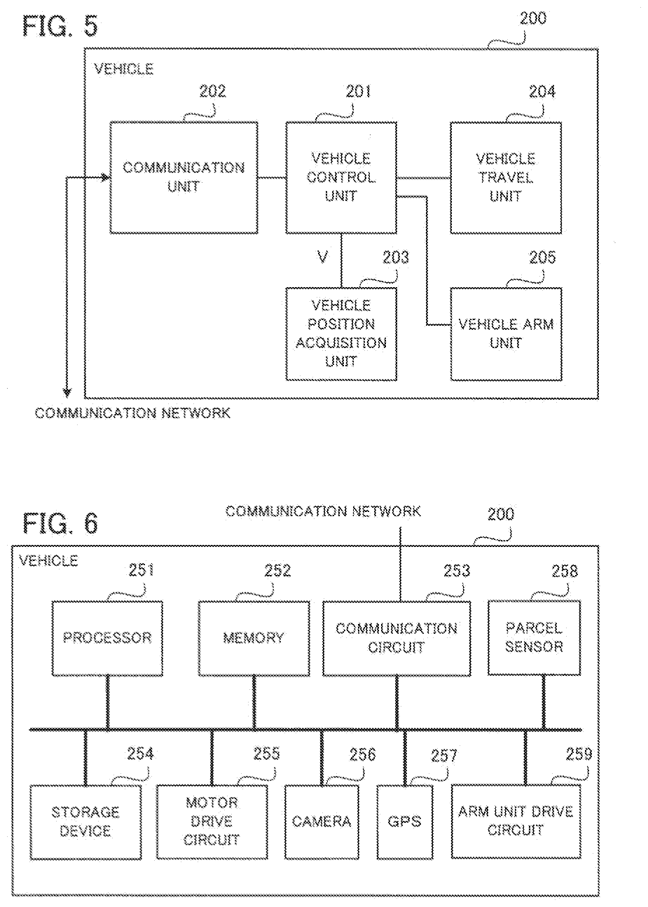

FIG. 5 is a functional block diagram schematically showing the configuration of the vehicle 200 in FIG. 1. As shown in FIG. 5, the vehicle 200 includes a communication unit 202 that executes communication with other devices such as the management server 100 via the communication network 600, a vehicle control unit 201 that controls the traveling of the vehicle 200, operations regarding the key 732 used for accessing the inside of the storage space (e.g., the automobile 731) as the delivery destination or the delivery source, parcel loading/unloading work, and so forth, a vehicle position acquisition unit 203 such as a GPS (Global Positioning System) that acquires the vehicle position information as the position of the vehicle 200 (i.e., the position of the host vehicle 200), a vehicle travel unit 204 that drives a motor and the like for making the vehicle 200 travel, and the vehicle arm unit 205 that executes the operations regarding the key 732 used for accessing the inside of the storage space (e.g., the automobile 731) as the delivery destination or the delivery source and the parcel loading/unloading work (i.e., movement of the parcel). The key 732 is a key with which the automobile 731 as the storage space can be unlocked and locked. The key 732 can also be a key that remotely executes the unlocking and the locking (referred to also as a “smart key”). The storage space can be either the passenger space or the trunk of the automobile 731, for example.

The vehicle arm unit 205 includes a first operation execution unit that executes the unlocking and the locking of the storage space by using the key 732, for example. Further, the vehicle arm unit 205 includes a second operation execution unit that executes the movement of the parcel between the storage space and the storage compartment of the vehicle 200, for example. The vehicle arm unit 205 may include both of the first operation execution unit that executes the unlocking and the locking of the storage space by using the key 732 and the second operation execution unit that executes the movement of the parcel between the storage space and the storage compartment of the vehicle 200. Alternatively, the vehicle arm unit 205 can be a mechanism capable of executing the unlocking and the locking of the storage space by using the key 732 and the movement of the parcel between the storage space and the storage compartment of the vehicle 200. The vehicle arm unit 205 is, for example, a robot arm (i.e., multijoint arm mechanism or multijoint arm system or robot arm system) capable of performing motions similar to those of a human's hand and arm. In cases where a staff for executing the unlocking and the locking of the storage space and the movement of the parcel is arranged in the parking facility 730, even a vehicle 200 not equipped with the vehicle arm unit 205 is usable.

The vehicle control unit 201 controls the operation of the vehicle travel unit 204 and the vehicle arm unit 205 based on the vehicle position information V, the traveling command received from the management server 100, and the like. Further, when the host vehicle 200 is the responsible vehicle 210, the vehicle control unit 201 transmits the pickup completion notification indicating that the responsible vehicle 210 arrived at the user present position and the shipment parcel and the key 732 have been loaded onto the responsible vehicle 210, the delivery/pickup completion notification indicating that the responsible vehicle 210 arrived at the storage space as the delivery destination or the delivery source, accessed the inside of the storage space as the delivery destination or the delivery source by using the key 732, and has executed the unloading or the loading of the parcel, or the delivery completion notification indicating that the responsible vehicle 210 arrived at the user present position and the reception parcel and the key have been taken out from the responsible vehicle 210. Furthermore, the vehicle control unit 201 may execute a process for authenticating the user storing the parcel or the user taking out the parcel from the storage compartment. The authentication can be carried out by means of near field communication with the user terminal 300, the inputting of a password, or the like, for example.

FIG. 6 is a diagram showing an example of the hardware configuration of the vehicle 200 in FIG. 5. As shown in FIG. 6, the vehicle 200 includes a processor 251 such as a CPU, a memory 252 as a volatile storage device, a communication circuit 253 that executes the communication, a nonvolatile storage device 254, a motor drive circuit 255 that drives the motor for the traveling of the vehicle, a camera 256 that photographs the vicinity of the vehicle 200, a GPS 257, a parcel sensor 258 that detects the parcel, and an arm unit drive circuit 259 that makes the vehicle arm unit 205 operate to execute the operations regarding the key 732 and the parcel loading/unloading. The vehicle 200 is a device equipped with a computer, for example. The vehicle 200 may include a distance measurement sensor such as a LiDAR (Light Detection And Ranging) or a radar in addition to the camera 256 and use a captured image or information on a detected object for the control of the autonomous traveling of the vehicle 200, detection of an insertion position for the key 732, and so forth. Further, the vehicle 200 may include the parcel sensor 258 for detecting a state in which a parcel has been stored or no parcel has been stored and a function of notifying the management server 100 of the result of the detection by the parcel sensor 258. The parcel sensor 258 may be used for identifying the parcel (i.e., for determining whether or not the parcel is the target of delivery).

Functions of the vehicle 200 are implemented by processing circuitry. The processing circuitry can be either dedicated hardware or the processor 251 executing a program stored in the memory 252. It is also possible to implement part of the configuration of a control system of the vehicle 200 by dedicated hardware and part of the configuration of the control system by software or firmware. As above, the processing circuitry is capable of implementing the above-described functions by hardware, software, firmware or a combination of some of these means. The memory 252 and the storage device 254 may be a non-transitory computer-readable storage medium, i.e., a non-transitory tangible storage medium storing a program.

### (User Terminal 300)

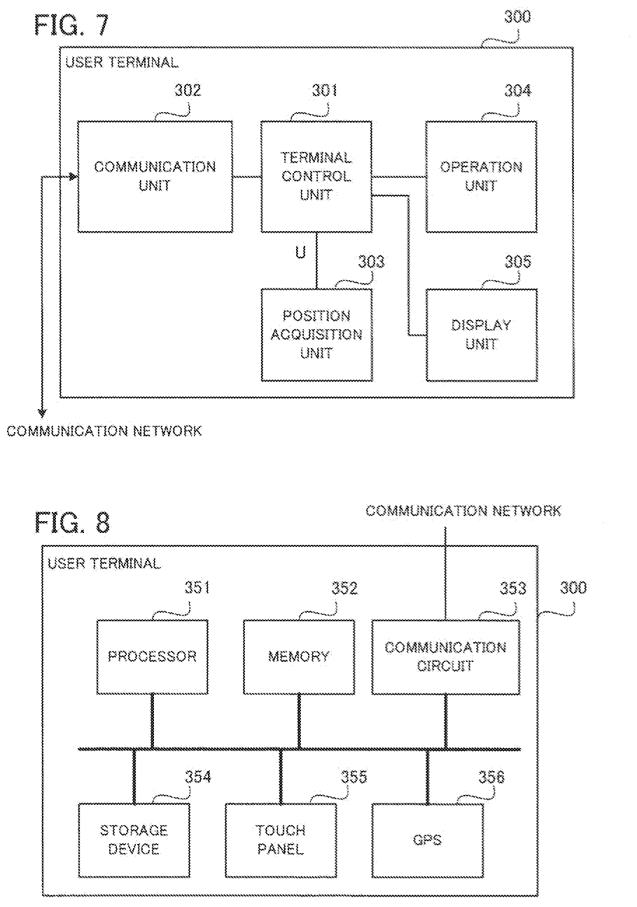

FIG. 7 is a functional block diagram schematically showing the configuration of the user terminal 300 in FIG. 1. As shown in FIG. 7, the user terminal 300 includes a communication unit 302 that executes communication with other devices such as the management server 100 via the communication network 600, a terminal control unit 301, a position acquisition unit 303 such as a GPS that acquires the user position information U, an operation unit 304 on which user operations are performed, and a display unit 305 that displays information. The user terminal 300 is a smartphone (i.e., small-sized computer), for example. The terminal control unit 301 transmits a delivery request to the management server 100. Further, the terminal control unit 301 may be used for the authentication of the user when a parcel is stored in the vehicle 200 or when a parcel is taken out of the storage compartment. The authentication can be carried out by means of near field communication with the vehicle 200, for example.

FIG. 8 is a diagram showing an example of the hardware configuration of the user terminal 300 in FIG. 7. As shown in FIG. 8, the user terminal 300 includes a processor 351 such as a CPU, a memory 352 as a volatile storage device, a communication circuit 353 that executes the communication, a nonvolatile storage device 354, a touch panel 355, and a GPS 356.

Functions of the user terminal 300 are implemented by processing circuitry. The processing circuitry can be either dedicated hardware or the processor 351 executing a program stored in the memory 352. It is also possible to implement part of the configuration of the user terminal 300 by dedicated hardware and part of the configuration of the user terminal 300 by software or firmware. As above, the processing circuitry is capable of implementing the above-described functions by hardware, software, firmware or a combination of some of these means. The memory 352 and the storage device 354 may be a non-transitory computer-readable storage medium, i.e., a non-transitory tangible storage medium storing a program.

### (Shop Terminal 400)

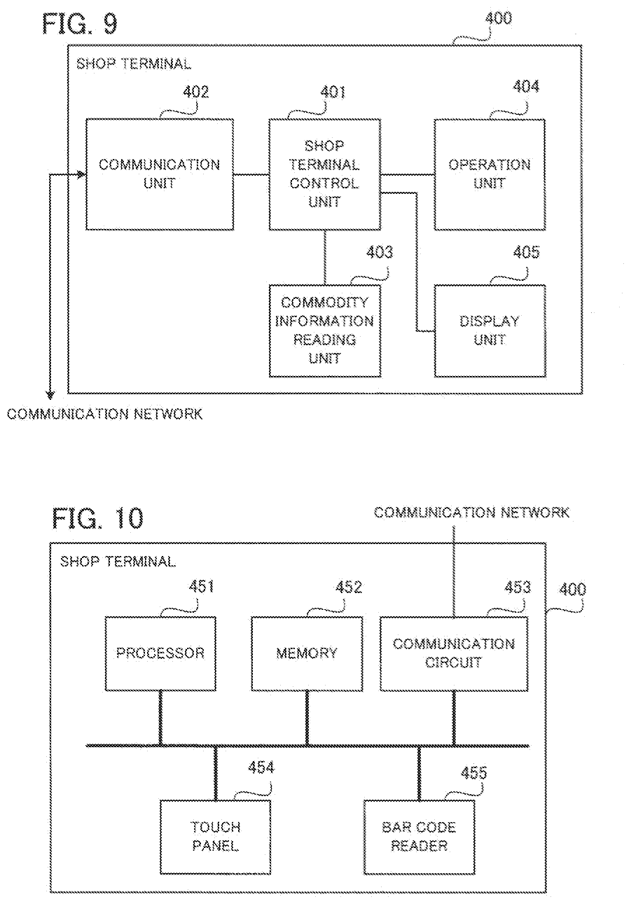

FIG. 9 is a functional block diagram schematically showing the configuration of the shop terminal 400 in FIG. 1. As shown in FIG. 9, the shop terminal 400 includes a communication unit 402 that executes communication with other devices such as the management server 100 via the communication network 600, a shop terminal control unit 401, a commodity information reading unit 403 that reads a bar code as identification information on a commodity for sale, an operation unit 404 on which operations are performed, and a display unit 405 that displays information. The shop terminal 400 is a computer, for example. The shop terminal control unit 401 transmits a delivery request to the management server 100. Further, the shop terminal control unit 401 may transmit the parcel delivery request to the management server 100 in place of the user terminal 300. In this case, the shop terminal control unit 401 may transmit commodity information read by the commodity information reading unit 403 as information on the parcel to be delivered.

FIG. 10 is a diagram showing an example of the hardware configuration of the shop terminal 400 in FIG. 9. As shown in FIG. 10, the shop terminal 400 includes a processor 451 such as a CPU, a memory 452 as a volatile storage device, a communication circuit 453 that executes the communication, a touch panel 454, and a bar code reader 455.

Functions of the shop terminal 400 are implemented by processing circuitry. The processing circuitry can be either dedicated hardware or the processor 451 executing a program stored in the memory 452. It is also possible to implement part of the configuration of the shop terminal 400 by dedicated hardware and part of the configuration of the shop terminal 400 by software or firmware. As above, the processing circuitry is capable of implementing the above-described functions by hardware, software, firmware or a combination of some of these means. The memory 452 may be a non-transitory computer-readable storage medium, i.e., a non-transitory tangible storage medium storing a program.

### (Hotel Terminal 500)

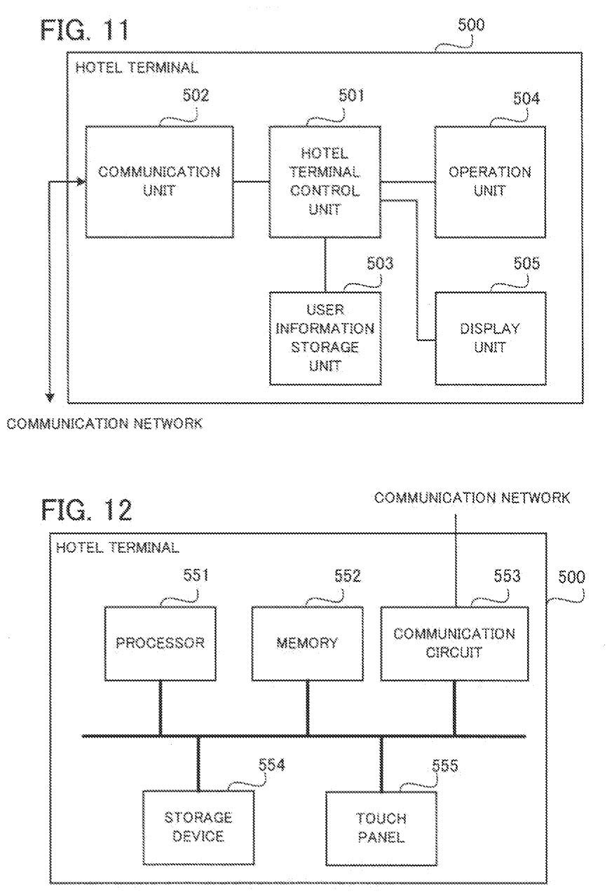

FIG. 11 is a functional block diagram schematically showing the configuration of the hotel terminal 500 in FIG. 1. As shown in FIG. 11, the hotel terminal 500 includes a communication unit 502 that executes communication with other devices such as the management server 100 via the communication network 600, a hotel terminal control unit 501, a storage unit 503 that stores the user information, an operation unit 504 on which input operations are performed, and a display unit 505 that displays information. The hotel terminal 500 is a computer, for example. The hotel terminal control unit 501 is used for communication for storing the parcel to be delivered to the user in the storage compartment of the vehicle 200 arriving at the hotel 510 based on a request from the management server 100. Further, the hotel terminal control unit 501 may transmit the parcel delivery request to the management server 100 in place of the user terminal 300.

FIG. 12 is a diagram showing an example of the hardware configuration of the hotel terminal 500 in FIG. 11. As shown in FIG. 12, the hotel terminal 500 includes a processor 551 such as a CPU, a memory 552 as a volatile storage device, a communication circuit 553 that executes the communication, a nonvolatile storage device 554, and a touch panel 555.

Functions of the hotel terminal 500 are implemented by processing circuitry. The processing circuitry can be either dedicated hardware or the processor 551 executing a program stored in the memory 552. It is also possible to implement part of the configuration of the hotel terminal 500 by dedicated hardware and part of the configuration of the hotel terminal 500 by software or firmware. As above, the processing circuitry is capable of implementing the above-described functions by hardware, software, firmware or a combination of some of these means. The memory 552 and the storage device 554 may be a non-transitory computer-readable storage medium, i.e., a non-transitory tangible storage medium storing a program.

### First Operation Example

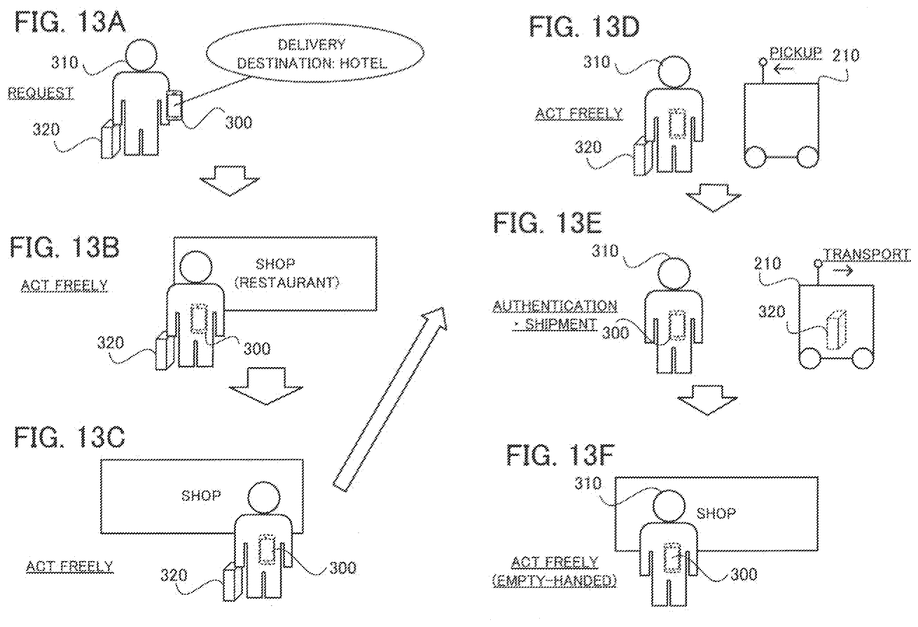

FIGS. 13A to 13F are schematic diagrams for explaining a first operation example of the delivery system according to the embodiment. First, as shown in FIG. 13A, the user 310 requesting the delivery of a parcel 320 transmits a delivery request from the user terminal 300. The delivery request includes information indicating that the delivery destination is the hotel 510 as the accommodation. Further, the delivery request may include size information on the shipment parcel as the parcel 320 to be shipped. Furthermore, the delivery request may include designation of a pickup time such as “Please pick up about one hour from now.”, “Please pick up in over one hour from now.”, “Please pick up within one hour from now.”, or the like, for example.

As shown in FIGS. 13B and 13C, the user 310 after making the delivery request does not need to wait at a designated place at a set time, and thus can act and move freely in the area 700.

Thereafter, as shown in FIG. 13D, the responsible vehicle 210 arrives at the position of the user 310 freely acting and moving. At that time, the user 310 is notified that the responsible vehicle 210 has arrived to pick up the parcel by means of audio output, a display on a display unit of the responsible vehicle 210, a notification to the user terminal 300, or the like.

As shown in FIG. 13E, the responsible vehicle 210 (or the management server 100) performs authentication that the user 310 is the actual person who requested the delivery, and the responsible vehicle 210 moves to the delivery destination (e.g., the hotel 510) after the parcel 320 is loaded onto the storage compartment of the responsible vehicle 210. Further, the responsible vehicle 210 notifies the management server 100 that the pickup is completed.

Thereafter, as shown in FIG. 13F, the user 310 can act freely (e.g., sightseeing, shopping, eating, etc.) empty-handed.

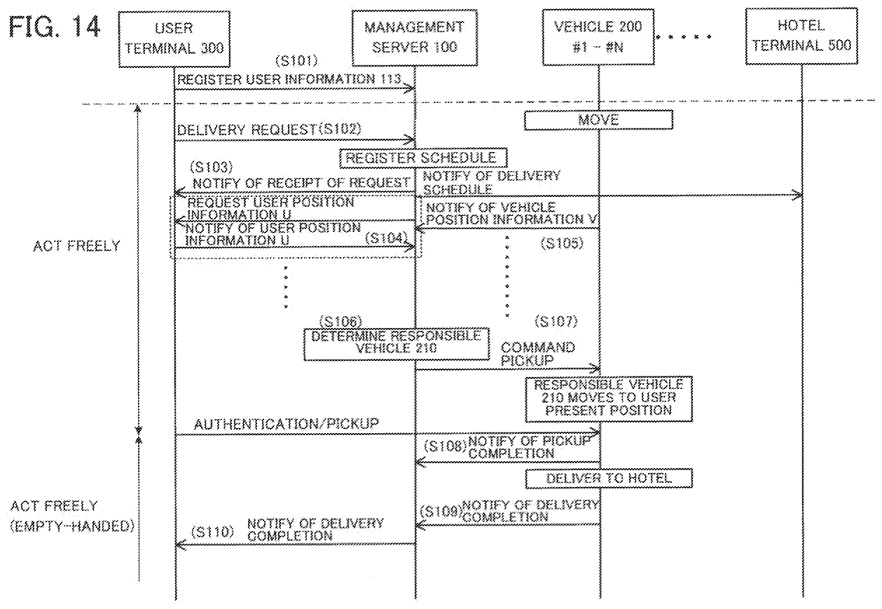

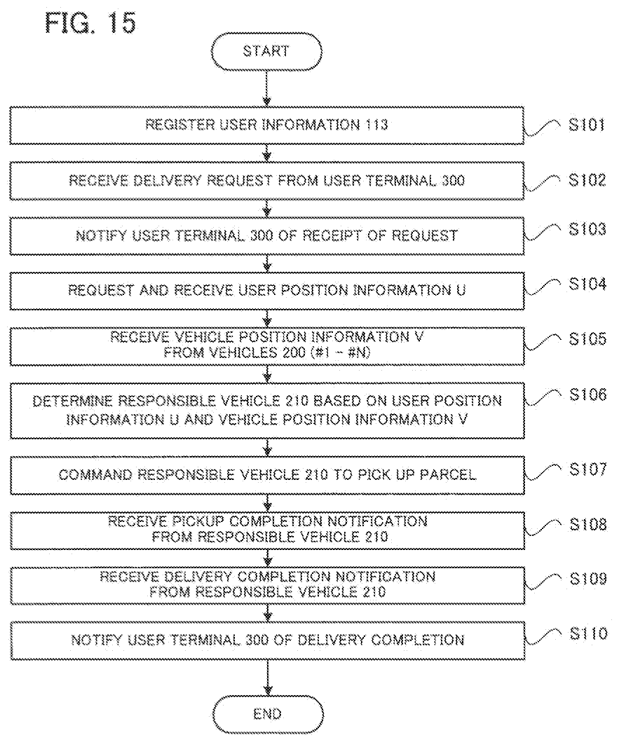

FIG. 14 is a sequence diagram showing the operation of the user terminal 300, the responsible vehicle 210 and the management server 100 in the first operation example. FIG. 15 is a flowchart showing the operation of the management server 100 in the first operation example.

First, in step S101, the user information is registered in the management server 100. The registration of the user information may be performed at the same time as an accommodation reservation for the hotel 510.

Subsequently, in step S102, a delivery request is made to the management server 100. The management server 100 registers the delivery in a schedule list, and notifies the user terminal 300 of the receipt of the request in step S103. Further, the management server 100 may notify the hotel terminal 500 of the hotel 510 as the delivery destination about the delivery schedule.

Subsequently, in step S104, the management server 100 repeats a process of requesting the user position information U from the user terminal 300 and receiving the user position information U from the user terminal 300 until the pickup by the responsible vehicle 210 is completed. In step S105, the management server 100 receives vehicle position information V from the vehicles 200 (#1-#N). Further, the management server 100 in step S106 selects the responsible vehicle 210 to be dispatched for the pickup from among the vehicles 200 #1-#N moving in the area 700, and issues a command regarding the traveling for the pickup in step S107. The responsible vehicle 210 moves to the position of the user 310 freely acting and moving and notifies the user 310 that the responsible vehicle 210 has arrived to pick up the parcel.

Subsequently, the responsible vehicle 210 (or the management server 100) performs the authentication that the user 310 is the actual person who requested the delivery, and the responsible vehicle 210 starts moving toward the hotel 510 as the delivery destination after the parcel 320 is loaded onto the storage compartment of the responsible vehicle 210. Further, in step S108, the responsible vehicle 210 notifies the management server 100 that the pickup is completed.

Subsequently, in step S109, the responsible vehicle 210 notifies the management server 100 that the delivery to the hotel 510 is completed. In step S110, the management server 100 notifies the user terminal 300 of the delivery completion.

In the case of the first operation example, the user 310 does not need to be at a designated place at a set time for the pickup, and can act and move freely in the area 700.

### Second Operation Example

In the above-described first operation example, the description is given of the operation of the delivery system when the user 310 does not want to carry the parcel 320. However, there are cases where the user 310 wants to take a stroll in the area 700 together with a stuffed toy as a doll toy (e.g., while holding the stuffed toy in arms). Therefore, in a second operation example, a description will be given of a case where it is speculated that the user 310 wants to walk while carrying a commodity purchased in the area 700.

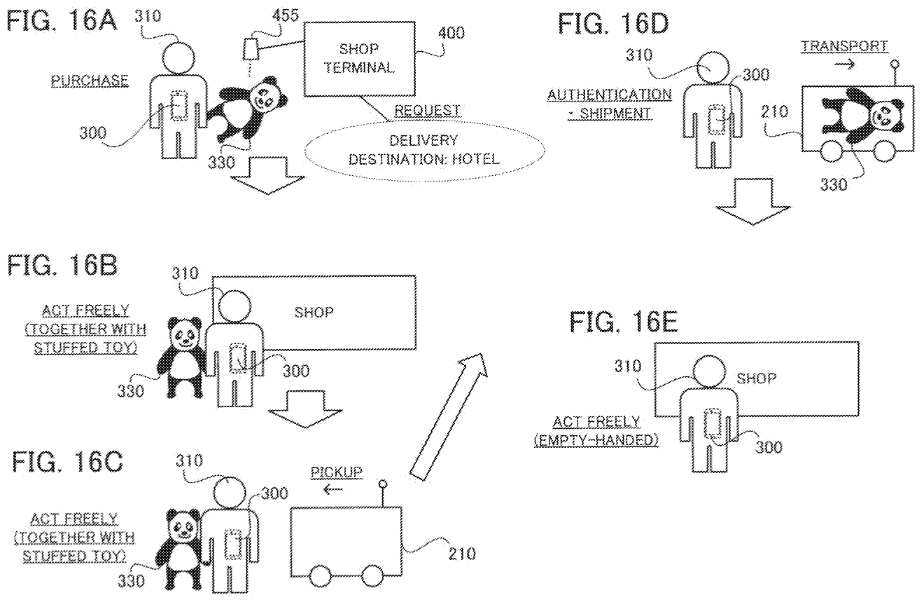

FIGS. 16A to 16E are schematic diagrams for explaining the second operation example of the delivery system according to the embodiment. First, as shown in FIG. 16A, the user 310 requesting the delivery of a parcel 330 as a purchased commodity transmits a delivery request from the shop terminal 400. The delivery request includes information indicating that the delivery destination is the hotel 510 as the accommodation. Further, the delivery request may include parcel information (e.g., size information) regarding the shipment parcel as the parcel 330 to be shipped. The parcel information can be information obtained by reading a bar code of the commodity with a bar code reader. Furthermore, the delivery request may include, for example, specific designation regarding the pickup time, or rough designation regarding the pickup time such as “Please pick up in a short while from now”. Further, the delivery request in FIG. 16A may also be made by use of the user terminal 300.

Subsequently, as shown in FIG. 16B, the user 310 after making the delivery request does not need to wait at a designated place at a set time, and thus can act and move freely in the area 700 together with the stuffed toy.

Thereafter, as shown in FIG. 16C, the responsible vehicle 210 arrives at the position of the user 310 freely acting and moving. The management server 100 estimates a desirable time until the responsible vehicle 210 arrives at the user position based on the user information on the user 310 (e.g., attributes of the user), commodity information on the purchased commodity (e.g., size and weight of the commodity), the type of the facility where the user is strolling, and the like. This estimation may be performed by using a learned model previously obtained by machine learning based on attributes of users, commodity information on purchased commodities, types of facilities for strolling, and the like. Upon arrival at the user position, the responsible vehicle 210 is desired to notify the user 310 of the arrival by means of audio output, a display on the display unit of the responsible vehicle 210, a notification to the user terminal 300, or the like.

Subsequently, as shown in FIG. 16D, the responsible vehicle 210 (or the management server 100) performs the authentication that the user 310 is the actual person who requested the delivery, and the responsible vehicle 210 moves to the delivery destination (e.g., the hotel 510) after the parcel 330 is loaded onto the storage compartment of the responsible vehicle 210. Further, the responsible vehicle 210 notifies the management server 100 that the pickup is completed.

Thereafter, as shown in FIG. 16F, the user 310 can act freely (e.g., sightseeing, shopping, eating, etc.) empty-handed.

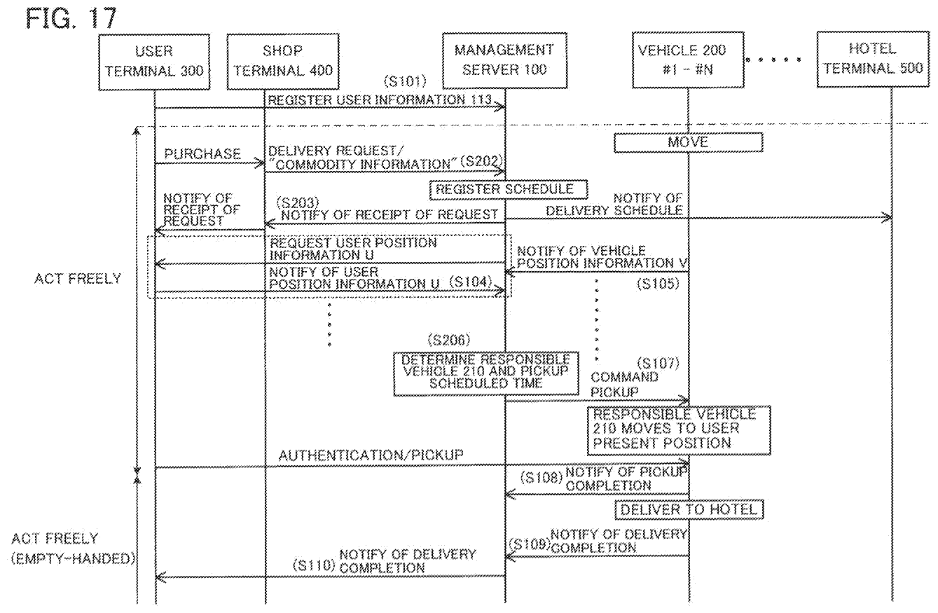

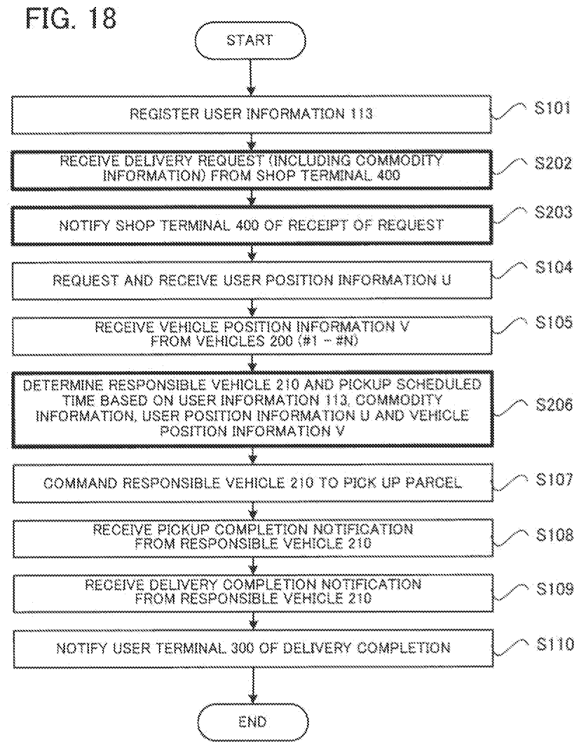

FIG. 17 is a sequence diagram showing the operation of the user terminal 300, the vehicles 200 and the management server 100 in the second operation example. FIG. 18 is a flowchart showing the operation of the management server 100 in the second operation example. FIGS. 17 and 18 differ from the first operation example shown in FIG. 14 and FIG. 15 in that the shop terminal 400 transmits the delivery request and a request receipt notification is transmitted to the shop terminal 400 (or both of the shop terminal 400 and the user terminal 300) (steps S202 and S203) and the management server 100 determines the responsible vehicle 210 and the pickup time based on the user information 113, the commodity information, the user position information U and the vehicle position information V (step S206). Except for the above-described features, the second operation example is the same as the first operation example.

In the case of the second operation example, the user 310 does not need to be at a designated place at a set time for the pickup, and can act and move freely in the area 700.

Further, the user 310 can take a stroll in the facility together with the purchased stuffed toy for an appropriate time not making the user 310 too tired, and thus the level of enjoyment felt by the user 310 can be increased and the user 310's level of satisfaction with the use of the facility can be increased.

### Third Operation Example

In the above-described first and second operation examples, the description is given of the operation of the delivery system for delivering the parcel 320 to the hotel 510 as a facility other than the commercial facility 710. However, there are cases where the user 310 exiting from the commercial facility 710 goes to a different facility (e.g., the entertainment facility 720). Therefore, in a third operation example, a description will be given of a case where the user 310 receives a parcel 340 as the user 310's own bag at an exit of the commercial facility 710.

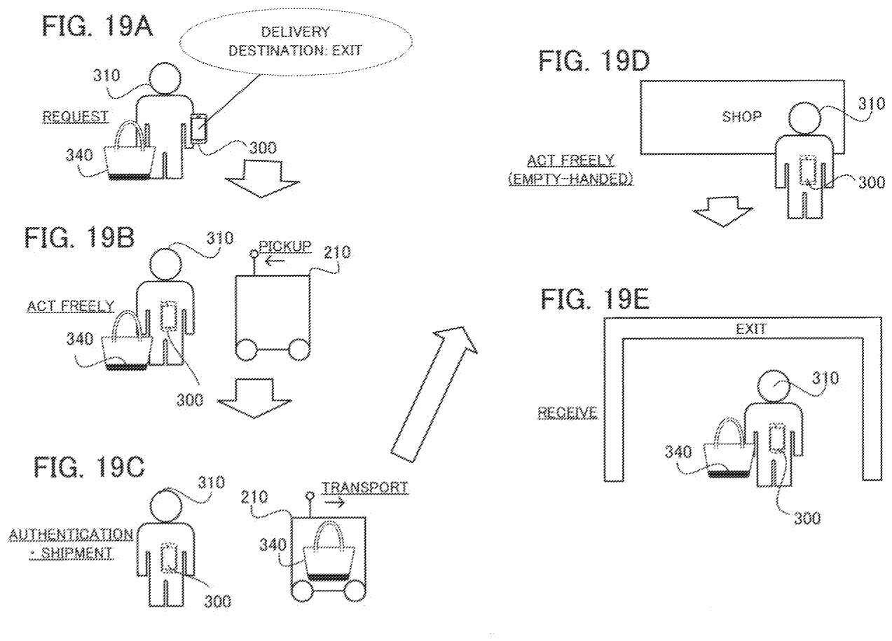

FIGS. 19A to 19E are schematic diagrams for explaining the third operation example of the delivery system according to the embodiment. First, as shown in FIG. 19A, the user 310 requesting the delivery of the parcel 340 transmits a delivery request from the user terminal 300. The delivery request includes information indicating that the delivery destination is an exit of the commercial facility 710 in which the user 310 is currently situated (e.g., parcel receiving place in the vicinity of the exit). A facility terminal as a computer is provided in the parcel receiving place in the vicinity of the exit and executes processes such as authentication for the reception of the parcel 340 by the user 310. The configuration of the facility terminal is the same as that of the hotel terminal.

Subsequently, as shown in FIG. 19B, the user 310 after making the delivery request does not need to wait at a designated place at a set time, and thus can act and move freely in the commercial facility 710.

Thereafter, as shown in FIG. 19C, the responsible vehicle 210 arrives at the position of the user 310 freely acting and moving. The responsible vehicle 210 (or the management server 100) performs the authentication that the user 310 is the actual person who requested the delivery, and the responsible vehicle 210 moves to the exit as the delivery destination after the parcel 340 is loaded onto the storage compartment of the responsible vehicle 210. Further, the responsible vehicle 210 notifies the management server 100 that the pickup is completed.

Thereafter, as shown in FIG. 19D, the user 310 can act freely (e.g., sightseeing, shopping, eating, etc.) empty-handed. As shown in FIG. 19E, the user 310 can receive the parcel 340 at the exit of the commercial facility 710 and move from the commercial facility 710 to another place.

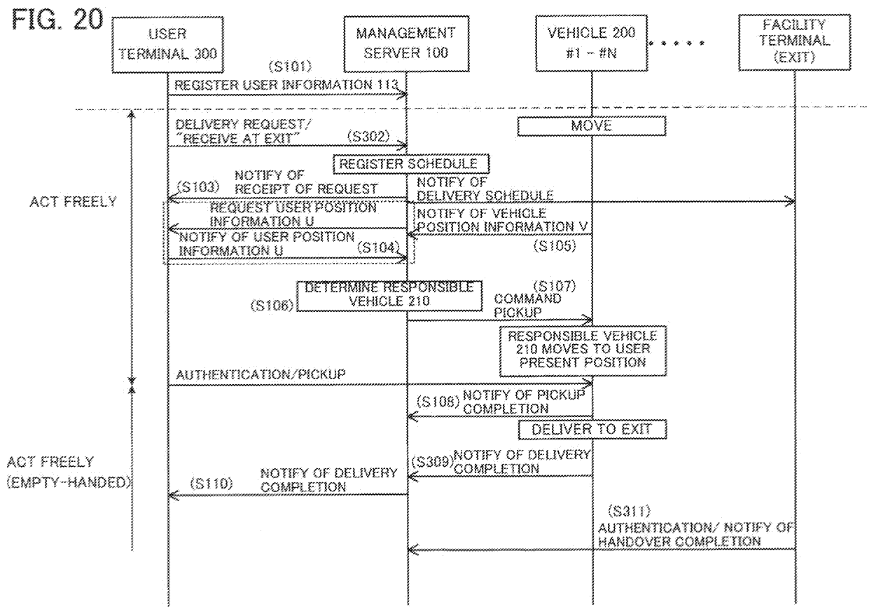

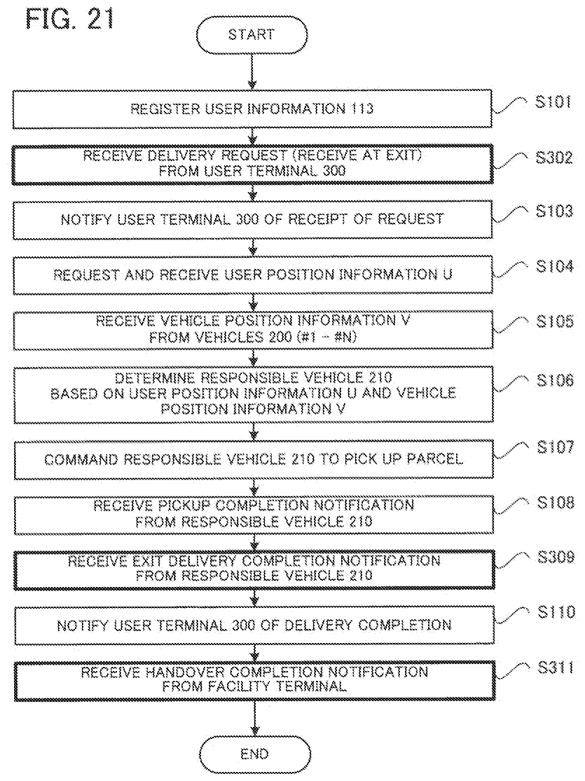

FIG. 20 is a sequence diagram showing the operation of the user terminal 300, the vehicles 200 and the management server 100 in the third operation example. FIG. 21 is a flowchart showing the operation of the management server 100 in the third operation example. FIG. 20 and FIG. 21 differ from the first operation example shown in FIG. 14 and FIG. 15 in that the delivery destination of the parcel 340 is the exit of the facility (step S302) and the management server 100 is notified that the parcel 340 has been delivered to the exit of the facility (step S309). Except for the above-described features, the third operation example is the same as the first operation example.

In the case of the third operation example, the user 310 does not need to be at a designated place at a set time for the pickup, and can act and move freely in the area 700.

### Fourth Operation Example

In the above-described first to third operation examples, the description is given of the operations in which the responsible vehicle 210 picks up a parcel of one user 310. However, there are cases where the user 310 does not need the pickup in a rush. In such cases, efficiency of the pickup increases if a responsible vehicle 210 having a plurality of storage compartments executes the pickup for a plurality of users successively. Therefore, in a fourth operation example, a description will be given of a case of using a responsible vehicle 210 having a plurality of storage compartments.

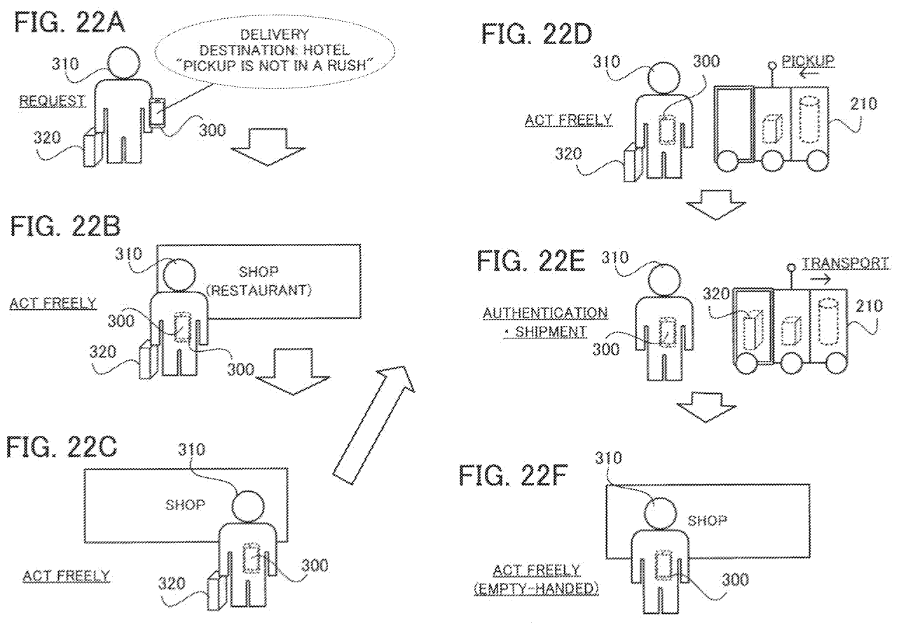

FIGS. 22A to 22F are schematic diagrams for explaining the fourth operation example of the delivery system according to the embodiment. First, as shown in FIG. 22A, the user 310 requesting the delivery of a parcel 320 transmits a delivery request from the user terminal 300. The delivery request includes information indicating that the delivery destination is the hotel 510 and “the pickup is not in a rush”.

Subsequently, as shown in FIGS. 22B and 22C, the user 310 after making the delivery request does not need to wait at a designated place at a set time, and thus can act and move freely in the commercial facility 710.

Thereafter, as shown in FIG. 22D, the responsible vehicle 210 having a plurality of storage compartments arrives at the position of the user 310 freely acting and moving. Subsequently, as shown in FIG. 22E, the responsible vehicle 210 (or the management server) performs the authentication that the user 310 is the actual person who requested the delivery, and the responsible vehicle 210 moves to the hotel 510 as the delivery destination after the parcel 340 is loaded onto one of the storage compartments of the responsible vehicle 210. Further, the responsible vehicle 210 notifies the management server 100 that the pickup is completed.

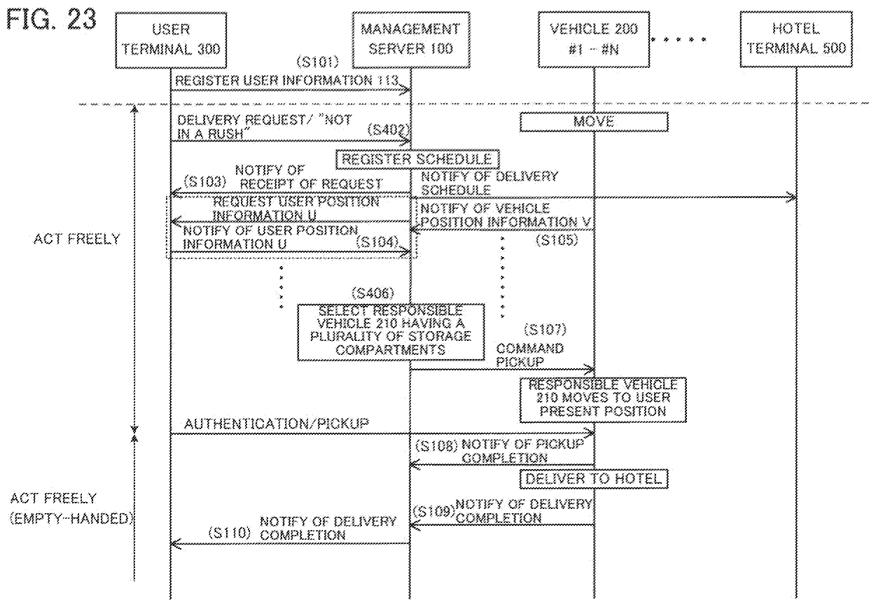

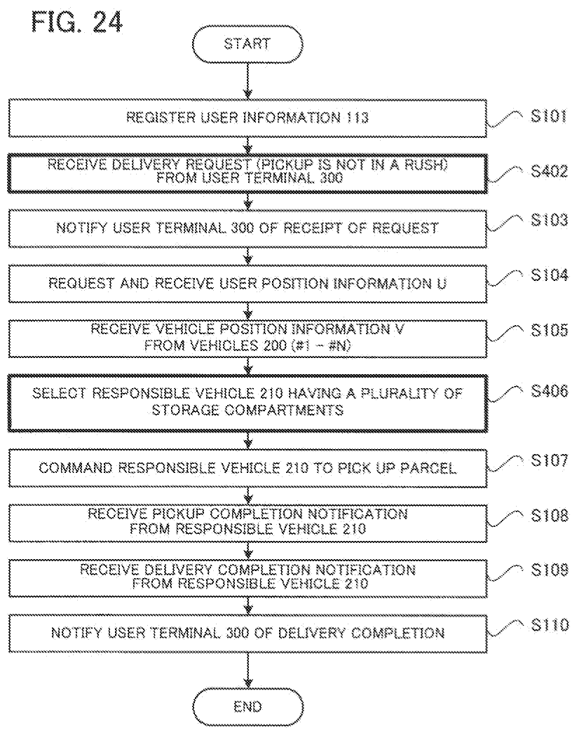

Thereafter, as shown in FIG. 22F, the user 310 can act freely (e.g., sightseeing, shopping, eating, etc.) empty-handed. FIG. 23 is a sequence diagram showing the operation of the user terminal 300, the vehicles 200 and the management server 100 in the fourth operation example. FIG. 24 is a flowchart showing the operation of the management server 100 in the fourth operation example. FIG. 23 and FIG. 24 differ from the first operation example shown in FIG. 14 and FIG. 15 in that the notification that the pickup of the parcel 320 is not in a rush is made (step S402) and the responsible vehicle 210 having a plurality of storage compartments is selected in this case (step S406). Except for the above-described features, the fourth operation example is the same as the first operation example.

In the case of the fourth operation example, the user 310 does not need to be at a designated place at a set time for the pickup, and can act and move freely in the area 700. Further, the efficiency of the pickup increases since a responsible vehicle 210 having a plurality of storage compartments is used.

### Fifth Operation Example

In the above-described first to fourth operation examples, the description is given of the operations in which information on the user 310 is used as the user information 113 or no user information 113 is used. However, there are cases where the convenience for the user 310 as a user of a facility is increased by using information on the user 310 and the family of the user 310. Therefore, in a fifth operation example, a description will be given of a case where the responsible vehicle 210 is determined in consideration of information on the user 310 as the delivery requester and the family of the user 310 (a group acting together with the user 310).

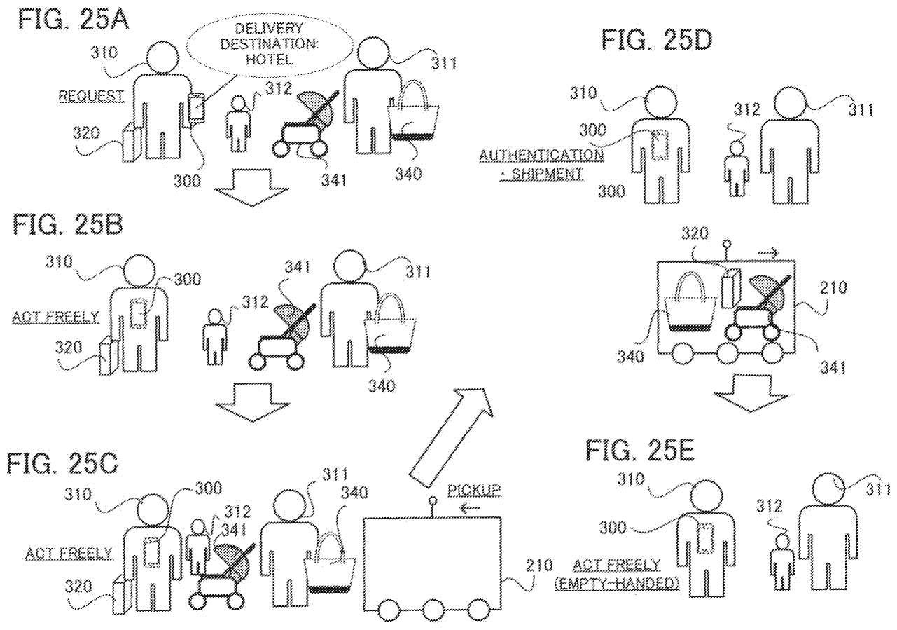

FIGS. 25A to 25E are schematic diagrams for explaining the fifth operation example of the delivery system according to the embodiment. First, as shown in FIG. 25A, the user 310 requesting the delivery of a parcel 320 transmits a delivery request from the user terminal 300. The delivery request includes information indicating that the delivery destination is the hotel 510, the user 310 is acting in a group of a total of three people including the user's wife and child, and the number of parcels is three.

Subsequently, as shown in FIG. 25B, the group of the user 310 after making the delivery request does not need to wait at a designated place at a set time, and thus can act and move freely in the commercial facility 710.

Thereafter, as shown in FIG. 25C, the responsible vehicle 210 having a storage compartment with a capacity greater than a predetermined normal (standard) capacity arrives at the position of the group of the user 310 freely acting and moving. The management server 100 estimates a desirable size of the storage compartment of the responsible vehicle 210 based on the user information 113 on the user 310 (e.g., family composition of the user). This estimation may be performed by using a learned model previously generated by machine learning based on attributes of users 310, compositions of families, commodity information on purchased commodities, types of facilities for strolling, and the like. For example, in cases where a child is at an age for riding in a stroller which is a relatively large parcel, the number of children is large, or the like, a storage compartment with a large capacity becomes necessary as the storage compartment of the responsible vehicle 210.

Subsequently, as shown in FIG. 25D, the responsible vehicle 210 (or the management server 100) performs the authentication that the user 310 is the actual person who requested the delivery, and the responsible vehicle 210 moves to the hotel 510 as the delivery destination after parcels 340, 341 and 320 are loaded onto the storage compartment of the responsible vehicle 210. Further, the responsible vehicle 210 notifies the management server 100 that the pickup is completed.

Thereafter, as shown in FIG. 25E, the user 310 can act freely (e.g., sightseeing, shopping, eating, etc.) empty-handed.

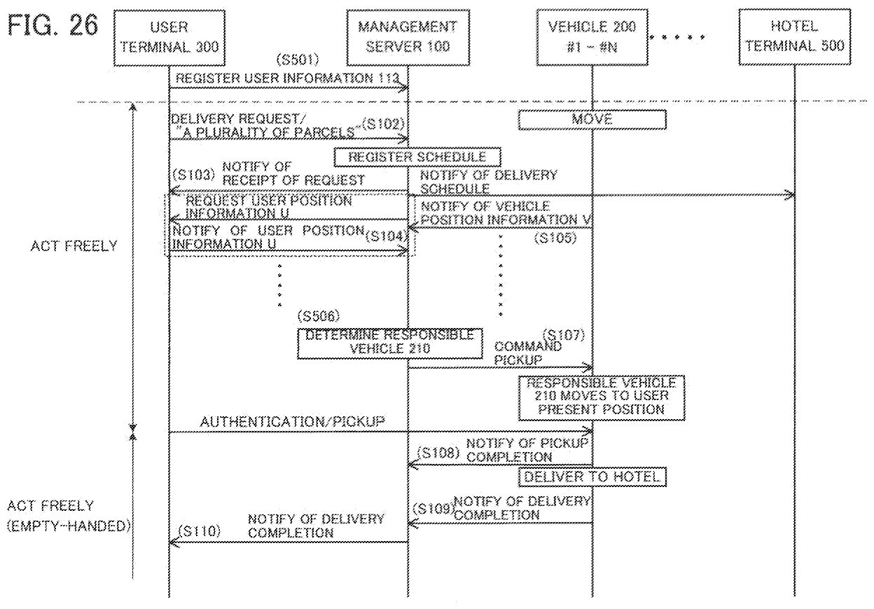

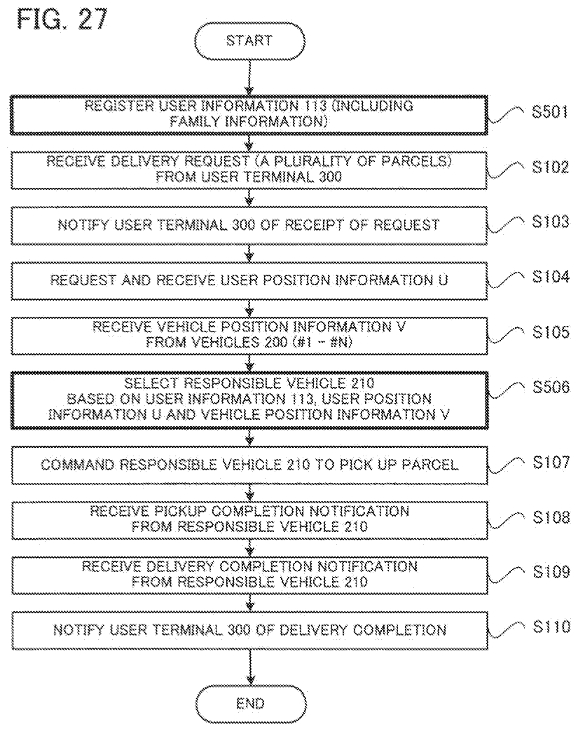

FIG. 26 is a sequence diagram showing the operation of the user terminal 300, the vehicles 200 and the management server 100 in the fifth operation example. FIG. 27 is a flowchart showing the operation of the management server 100 in the fifth operation example. FIG. 26 and FIG. 27 differ from the first operation example shown in FIG. 14 and FIG. 15 in that the user information 113 includes family information on the user (step S501) and the responsible vehicle 210 is selected (i.e., determined) based on the user information 113, the user position information U and the vehicle position information V (step S506). Except for the above-described features, the fifth operation example is the same as the first operation example.

In the case of the fifth operation example, the user 310 and the user's wife and child do not need to be at a designated place at a set time for the pickup, and can act and move freely in the area 700. Further, since it becomes possible to use a responsible vehicle 210 having a storage compartment with a large capacity, the parcels can be stored without fail.

### Sixth Operation Example

In the above-described first to fifth operation examples, the description is given of the operations of the delivery system in cases where the user 310 loads the shipment parcel onto the storage compartment of the responsible vehicle 210. In a sixth operation example, a description will be given of the operation of the delivery system in a case where the user 310 receives the reception parcel from the storage compartment of the responsible vehicle 210. Specifically, the description will be given of an operation example of the delivery system in a case where a coat left in the user 310's room in the hotel 510 is delivered to the user 310 walking in the commercial facility 710.

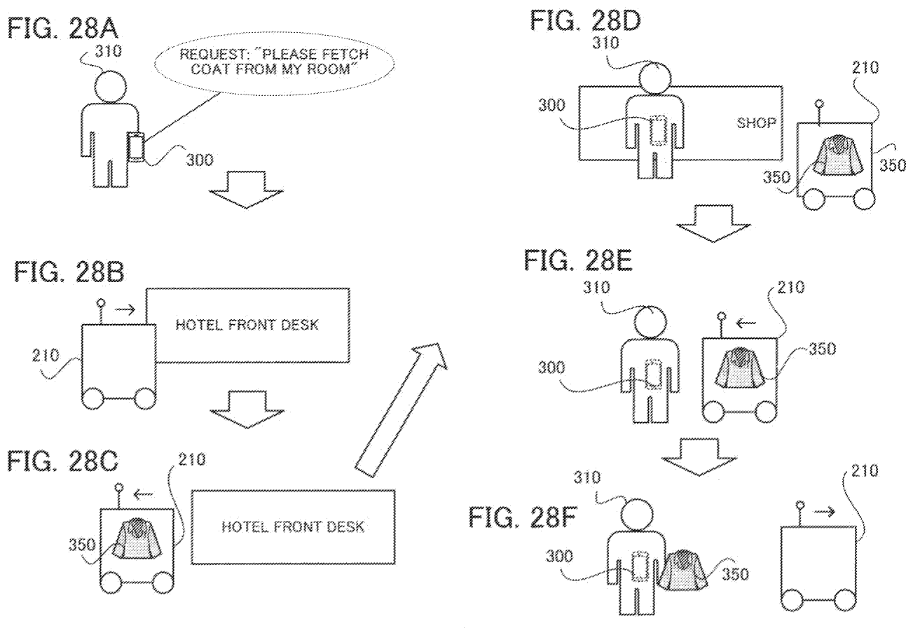

FIGS. 28A to 28F are schematic diagrams for explaining the sixth operation example of the delivery system according to the embodiment. First, as shown in FIG. 28A, a request for delivering a coat 350 as a parcel from the user 310's room in the hotel 510 to the user 310 in the commercial facility 710 is transmitted from the user terminal 300. The delivery request includes information indicating that the delivery destination is the user 310 moving in the area 700 and the parcel is the coat 350 left in the user's room in the hotel 510.

Subsequently, as shown in FIG. 28B, the responsible vehicle 210 is determined by the management server 100 and arrives at the hotel 510 (e.g., front desk) in the area 700. After the coat 350 is stored in the storage compartment of the responsible vehicle 210 by a clerk of the hotel 510 as shown in FIG. 28C, the responsible vehicle 210 arrives at the position of the user 310 freely acting and moving in the commercial facility 710 as shown in FIG. 28D.

Subsequently, as shown in FIG. 28E, the responsible vehicle 210 (or the management server 100) performs the authentication that the user 310 is the actual person who requested the delivery, and permits the taking out of the coat 350 stored in the storage compartment of the responsible vehicle 210. After the coat 350 is taken out of the responsible vehicle 210 as shown in FIG. 28F, the responsible vehicle 210 notifies the management server 100 that the delivery of the parcel picked up is completed.

Thereafter, the user 310 can wear the coat and act freely.

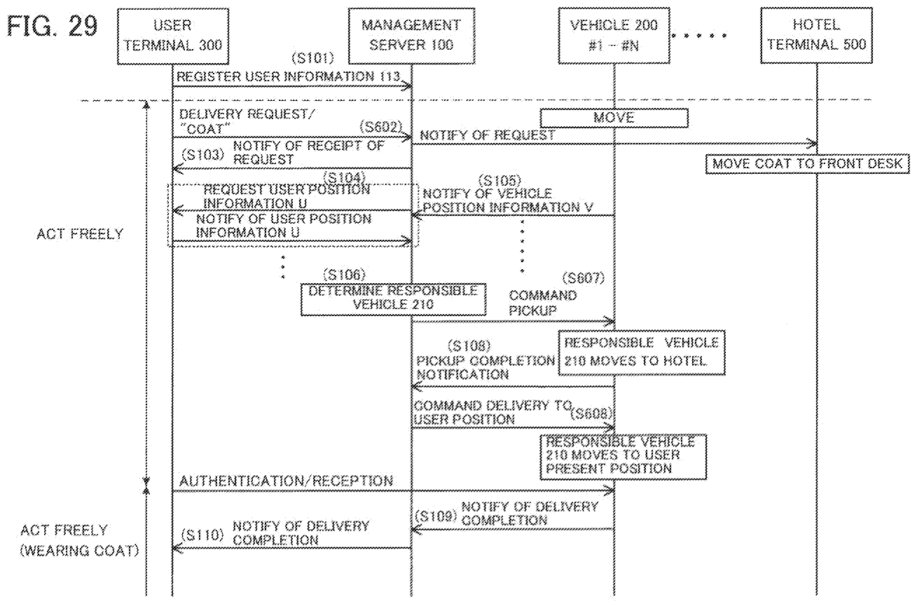

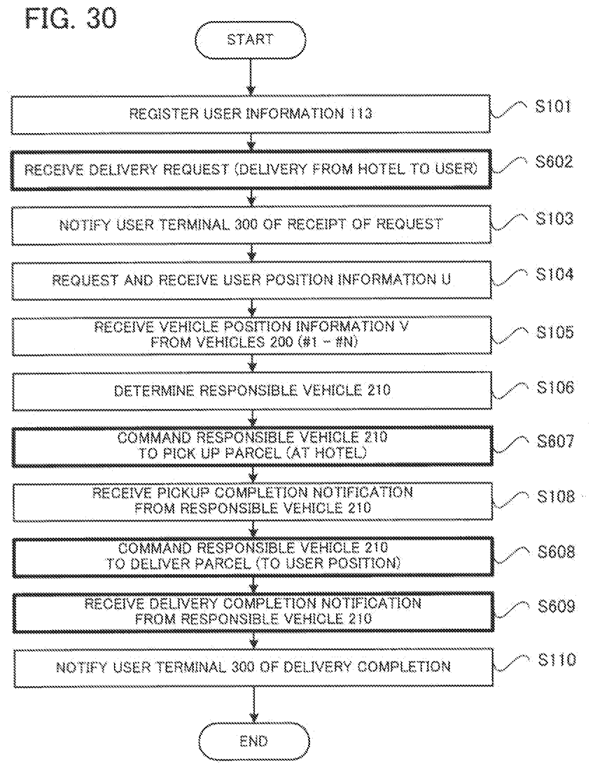

FIG. 29 is a sequence diagram showing the operation of the user terminal 300, the vehicles 200 and the management server 100 in the sixth operation example. FIG. 30 is a flowchart showing the operation of the management server 100 in the sixth operation example. FIG. 29 and FIG. 30 differ from the first operation example shown in FIG. 14 and FIG. 15 in that the pickup-delivery of picking up a parcel at the hotel 510 and delivering the parcel to the user 310 is requested (step S602) and the responsible vehicle 210 goes to the hotel 510, picks up the coat 350 as the parcel to be delivered to the user, and thereafter moves to the user position and delivers the parcel (steps S607, S608 and S609). Except for the above-described features, the sixth operation example is the same as the first operation example.

In the case of the sixth operation example, the user 310 does not need to be at a designated place at a set time for the pickup, and can act and move freely in the area 700.

### Seventh Operation Example

In the above-described first to sixth operation examples, the description is given of the operations of the delivery system in cases where the delivery destination or the delivery source is a place where there is a human (manpower) as typified by the hotel 510. In a seventh operation example, a description will be given of the operation of the delivery system in a case where the delivery source is the automobile 731 as the storage space parked in the parking facility 730. The parking facility 730 can also be a facility operated with no human (manpower). Specifically, the description will be given of an operation example of the delivery system in a case where the coat 350 left in the automobile 731 (e.g., in its trunk) usable (e.g., owned) by the user 310 is delivered to the user 310 walking in the commercial facility 710 (i.e., the user 310 freely acting and moving). Incidentally, the automobile 731 usable by the user 310 is referred to also as the automobile 731 of the user 310.

FIGS. 31A to 31G are schematic diagrams for explaining the seventh operation example of the delivery system according to the embodiment. First, as shown in FIG. 31A, a request for delivering the coat 350 as a parcel from the automobile 731 of the user 310 to the user 310 in the commercial facility 710 is transmitted from the user terminal 300. The delivery request includes information indicating that the delivery destination is the user 310 moving in the area 700, the delivery source is the automobile 731 of the user 310 and the key 732 is necessary for accessing the inside of the automobile 731, and the parcel is the coat 350 left in the automobile 731 of the user 310.

Subsequently, as shown in FIG. 31B, the responsible vehicle 210 is determined by the management server 100 and arrives at the position of the user 310 freely acting and moving in the commercial facility 710. After the responsible vehicle 210 (or the management server 100) performs the authentication that the user 310 is the actual person who requested the delivery and the key 732 of the automobile 731 is stored in the storage compartment of the responsible vehicle 210 by the user 310 as shown in FIG. 31C, the responsible vehicle 210 arrives at the automobile 731 owned by the user 310 and parked in the parking facility 730 as shown in FIG. 31D.

Subsequently, as shown in FIG. 31E, the responsible vehicle 210 using its vehicle arm unit 205 takes hold of the automobile 731's key 732 stored in its storage compartment, unlocks the automobile 731, takes out the coat 350 from the inside of the automobile 731, stores the coat 350 in the storage compartment, and locks the automobile 731. As shown in FIG. 31F, the responsible vehicle 210 arrives again at the position of the user 310 freely acting and moving in the commercial facility 710 and performs the authentication that the user 310 is the actual person who requested the delivery. Subsequently, after the coat 350 and the key 732 of the automobile 731 are taken out from the responsible vehicle 210 as shown in FIG. 31G, the responsible vehicle 210 notifies the management server 100 that the delivery of the parcel picked up is completed, and the user 310 notifies the management server 100 that the reception of the coat 350 as the designated parcel and the key 732 is completed.

Thereafter, the user 310 can wear the coat 350 and act freely.

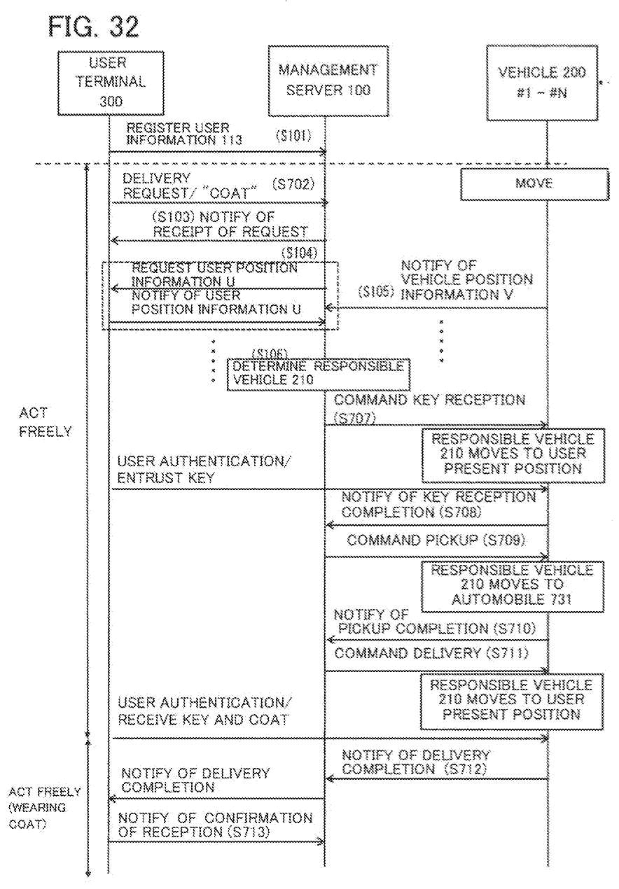

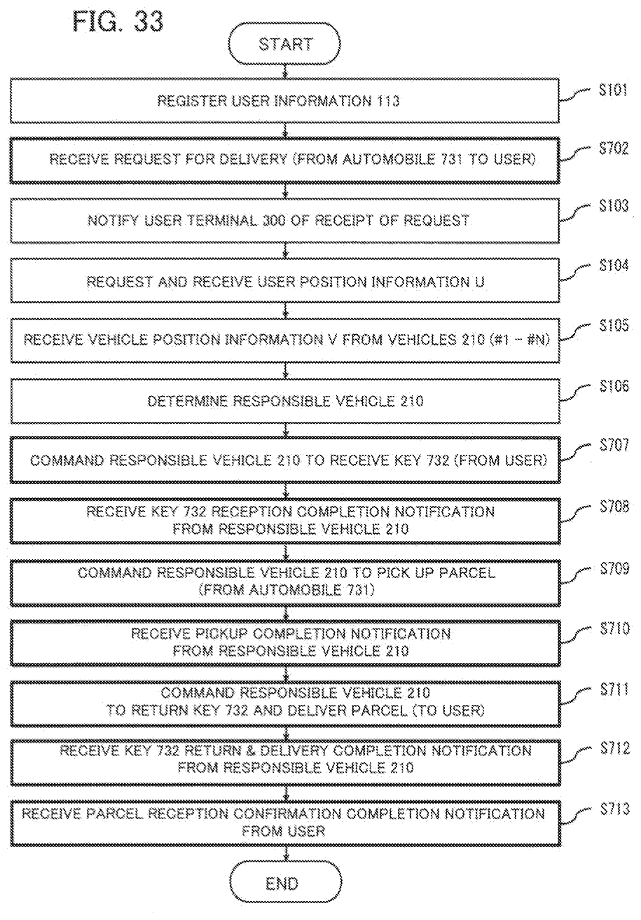

FIG. 32 is a sequence diagram showing the operation of the user terminal 300, the responsible vehicle 210 and the management server 100 in the seventh operation example. FIG. 33 is a flowchart showing the operation of the management server 100 in the seventh operation example.

First, in the step S101, the user information is registered in the management server 100. Subsequently, in step S702, a delivery request is made to the management server 100. The management server 100 registers the delivery in the schedule list, and notifies the user terminal 300 of the receipt of the request in the step S103.

Subsequently, in the steps S104 to S106, the management server 100 repeats the process of requesting the user position information U from the user terminal 300 and receiving the user position information U from the user terminal 300 until the pickup by the responsible vehicle 210 is completed and selects the responsible vehicle 210 to be dispatched for the pickup from among the vehicles 200 #1-#N moving in the area 700, and issues a command regarding the traveling for the pickup in step S707. The responsible vehicle 210 moves to the position of the user 310 freely acting and moving and notifies the user 310 that the responsible vehicle 210 has arrived to pick up the parcel.

Subsequently, the responsible vehicle 210 (or the management server 100) performs the authentication that the user 310 is the actual person who requested the delivery in step S708, and in step S709 after the key 732 is put in the storage compartment of the responsible vehicle 210, the responsible vehicle 210 is commanded to move to the automobile 731 parked in the parking facility 730 as the delivery source and pick up the parcel. In step S710, the responsible vehicle 210 notifies the management server 100 that the pickup is completed.

Subsequently, the responsible vehicle 210 is commanded by the management server 100 to return the key 732 and deliver the parcel in step S711, and the responsible vehicle 210 notifies the management server 100 of the completion of the return of the key 732 and the delivery in step S712. Thereafter, in step S713, the management server 100 receives a parcel reception confirmation completion notification from the user.

In the case of the seventh operation example, the user 310 does not need to be at a designated place at a set time for the pickup or the reception, and the coat 350 can be delivered from the automobile 731 parked in the parking facility 730 to the user 310 while the user 310 acts and moves freely in the area 700.

### Eighth Operation Example

In the above-described seventh operation example, the description is given of the operations of the delivery system in the case where the delivery source is the automobile 731 parked in the parking facility 730 and the delivery destination is the user 310 acting and moving freely in the area 700. In an eighth operation example, a description will be given of the operation of the delivery system in a case where the delivery source is the user 310 acting and moving freely in the area 700 and the delivery destination is the automobile 731 parked in the parking facility 730. Specifically, the description will be given of an operation example of the delivery system in a case where a coat 321 worn by the user 310 walking in the commercial facility 710 is delivered to the inside of the automobile 731 of the user 310 (e.g., the inside of the trunk).

FIGS. 34A to 34G are schematic diagrams for explaining the eighth operation example of the delivery system according to the embodiment. First, as shown in FIG. 34A, a request for delivering the coat 321 as a parcel from the user 310 in the commercial facility 710 to the inside of the automobile 731 of the user 310 is transmitted from the user terminal 300. The delivery request includes information indicating that the delivery source is the user 310 moving in the area 700, the delivery destination is the automobile 731 of the user 310 and the key 732 is necessary for accessing the inside of the automobile 731, and the parcel is the coat 321 included in the user 310's belongings.

Subsequently, as shown in FIG. 34B, the responsible vehicle 210 is determined by the management server 100 and arrives at the position of the user 310 freely acting and moving in the commercial facility 710. After the responsible vehicle 210 (or the management server 100) performs the authentication that the user 310 is the actual person who requested the delivery and the key 732 of the automobile 731 and the coat 321 are stored in the storage compartment of the responsible vehicle 210 by the user 310 as shown in FIG. 34C, the responsible vehicle 210 arrives at the automobile 731 owned by the user 310 and parked in the parking facility 730 as shown in FIG. 34D.

Subsequently, as shown in FIG. 34E, the responsible vehicle 210 using its vehicle arm unit 205 takes hold of the key 732 stored in its storage compartment, unlocks the automobile 731, stores the coat 321, which has been stored in the storage compartment, in the automobile 731, and locks the automobile 731. As shown in FIG. 34F, the responsible vehicle 210 arrives again at the position of the user 310 freely acting and moving in the commercial facility 710 and the responsible vehicle 210 (or the management server 100) performs the authentication that the user 310 is the actual person who requested the delivery, and after the key 732 of the automobile 731 is taken out by the user 310 as shown in FIG. 34G, the responsible vehicle 210 notifies the management server 100 that the return of the key 732 is completed, and the user 310 notifies the management server 100 that the reception of the key 732 is completed.

When the user 310 after finishing sightseeing or something arrives at the automobile 731 and successfully confirms that the coat 321 has been stored in the automobile 731, the user 310 notifies the management server 100 that the reception of the parcel is completed.

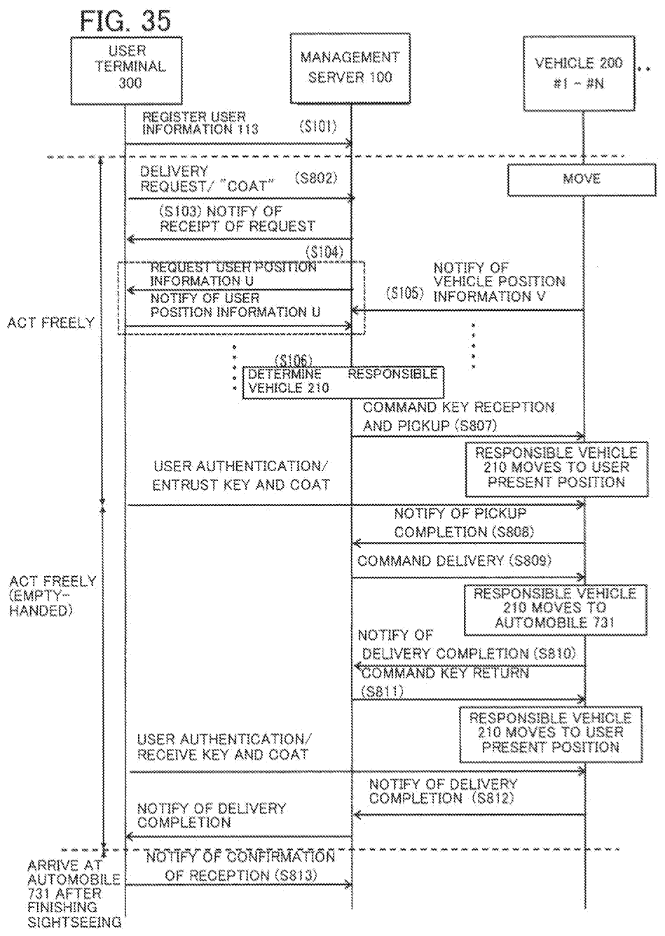

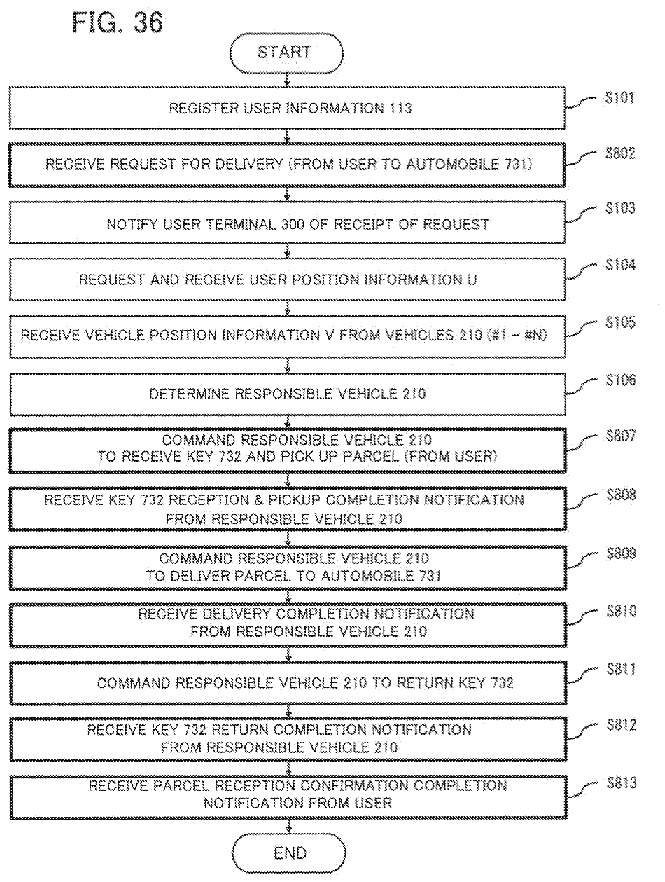

FIG. 35 is a sequence diagram showing the operation of the user terminal 300, the vehicles 200 and the management server 100 in the eighth operation example. FIG. 36 is a flowchart showing the operation of the management server 100 in the eighth operation example.

First, in the step S101, the user information is registered in the management server 100. Subsequently, in step S802, a delivery request is made to the management server 100. The management server 100 registers the delivery in the schedule list, and notifies the user terminal 300 of the receipt of the request in the step S103.

Subsequently, in the steps S104 to S106, the management server 100 repeats the process of requesting the user position information U from the user terminal 300 and receiving the user position information U from the user terminal 300 until the pickup by the responsible vehicle 210 is completed and selects the responsible vehicle 210 to be dispatched for the pickup from among the vehicles 200 #1-#N moving in the area 700, and gives a command for key acquisition and the pickup to the responsible vehicle 210 in step S807. The responsible vehicle 210 moves to the position of the user 310 freely acting and moving and notifies the user 310 that the responsible vehicle 210 has arrived to pick up the parcel.

Subsequently, in step S808, the responsible vehicle 210 performs the authentication that the user 310 is the actual person who requested the delivery, and notifies of the completion of the pickup.

Subsequently, the responsible vehicle 210 receives a command for the delivery in step S809, the responsible vehicle 210 moves to the automobile 731 parked in the parking facility 730 as the delivery destination, and receives the delivery completion notification in step S810. The pickup is commanded. In the step S810, the responsible vehicle 210 notifies the management server 100 that the pickup is completed.

Subsequently, the responsible vehicle 210 receives a key 732 return command from the management server 100 in step S811, and the responsible vehicle 210 notifies the management server 100 of the completion of the returning of the key 732 in step S812. Thereafter, in step S813, a parcel reception confirmation completion notification is received from the user.

In the case of the eighth operation example, the user 310 does not need to be at a designated place at a set time for the pickup or the reception, and can send the coat 321 to the automobile 731 while acting and moving freely in the area 700.

### Other Operation Examples

The management server 100 can freely combine operations described in the above first to eighth operation examples.

### DESCRIPTION OF REFERENCE CHARACTERS

100: management server (delivery management device), 101: control unit, 102: communication unit, 111: map information, 112: vehicle information, 113: user information, 115: storage space information, 200: vehicle, 205: vehicle arm unit, 210: responsible vehicle, 300: user terminal, 310: user, 320, 330, 340: parcel (shipment parcel), 321: coat, 350: parcel (reception parcel), 400: shop terminal, 500: hotel terminal (shipper terminal), 510: hotel (accommodation facility), 600: communication network, 700: area, 710: commercial facility, 720: entertainment facility, 730: parking facility, 731: automobile (storage space), 732: key.

What is claimed is:

1. A delivery management device comprising:
processing circuitry
to execute communication with a plurality of vehicles each of which autonomously travels in a previously set area and to output vehicle position information indicating a vehicle present position; and
to issue commands to the plurality of vehicles based on map information indicating a map of the area, vehicle information indicating types of the plurality of vehicles, user information that includes information regarding a user terminal outputting user position information indicating a user present position and information regarding a user, and storage space information including a position of a storage space that can be used by the user,
wherein upon receiving a delivery request for delivering a first parcel stored in the storage space locked to the user, the processing circuitry
selects one vehicle among the plurality of vehicles as a responsible vehicle based on one or more items of information out of contents of the delivery request, the map information, the vehicle information, the user information and the storage space information and makes the responsible vehicle move to the user present position while keeping track of the user in real time,
receives a key entrustment completion notification, indicating that a key of the storage space has been entrusted to the responsible vehicle, from the responsible vehicle,
makes the responsible vehicle move to the storage space and receives a pickup completion notification, indicating that the first parcel stored in the storage space unlocked by using the key has been loaded onto the responsible vehicle, from the responsible vehicle, and
makes the responsible vehicle move to the user present position again and receives a delivery & key return completion notification, indicating that the first parcel and the key have been taken out from the responsible vehicle, from the responsible vehicle.

2. The delivery management device according to claim 1, wherein upon receiving a delivery request for delivering a second parcel picked up from the user to the storage space, the processing circuitry
selects one vehicle among the plurality of vehicles as a responsible vehicle based on one or more items of information out of contents of the delivery request, the map information, the vehicle information, the user information and the storage space information and makes the responsible vehicle move to the user present position while keeping track of the user in real time,
receives a key entrustment completion notification indicating that a key of the storage space has been entrusted to the responsible vehicle and a pickup completion notification indicating that the second parcel has been loaded onto the responsible vehicle from the responsible vehicle,
makes the responsible vehicle move to the storage space and receives a delivery completion notification indicating that the second parcel has been stored in the storage space and a locking completion notification indicating that the storage space has been locked by using the key, and
makes the responsible vehicle move to the user present position again and receives a key return completion notification, indicating that the key has been returned to the user, from the responsible vehicle.

3. A delivery management device comprising:
processing circuitry
to execute communication with a plurality of vehicles each of which autonomously travels in a previously set area and to output vehicle position information indicating a vehicle present position; and
to issue commands to the plurality of vehicles based on map information indicating a map of the area, vehicle information indicating types of the plurality of vehicles, user information that includes information regarding a user terminal outputting user position information indicating a user present position and information regarding a user, and storage space information including a position of a storage space that can be used by the user,
wherein upon receiving a delivery request for delivering a second parcel picked up from the user to the storage space, the processing circuitry
selects one vehicle among the plurality of vehicles as a responsible vehicle based on one or more items of information out of contents of the delivery request, the map information, the vehicle information, the user information and the storage space information and makes the responsible vehicle move to the user present position while keeping track of the user in real time,
receives a key entrustment completion notification indicating that a key of the storage space has been entrusted to the responsible vehicle and a pickup completion notification indicating that the second parcel has been loaded onto the responsible vehicle from the responsible vehicle,
makes the responsible vehicle move to the storage space and receives a delivery completion notification indicating that the second parcel has been stored in the storage space and a locking completion notification indicating that the storage space has been locked by using the key, and
makes the responsible vehicle move to the user present position again and receives a key return completion notification, indicating that the key has been returned to the user, from the responsible vehicle.

4. The delivery management device according to claim 1, wherein
the storage space is an automobile usable by the user, and
the key is a key with which the automobile can be unlocked and locked.

5. The delivery management device according to claim 1, wherein the processing circuitry
selects a vehicle including a storage compartment and a first operation execution unit to execute the unlocking and the locking of the storage space by using the key as the responsible vehicle, and
controls the first operation execution unit's operation using the key.

6. The delivery management device according to claim 1, wherein the processing circuitry
selects a vehicle including a storage compartment and a second operation execution unit to execute movement of the parcel between the storage space and the storage compartment as the responsible vehicle, and
controls the second operation execution unit's parcel movement operation.

7. The delivery management device according to claim 1, wherein the processing circuitry
selects a vehicle including a storage compartment, a first operation execution unit to execute the unlocking and the locking of the storage space by using the key, and a second operation execution unit to execute movement of the parcel between the storage space and the storage compartment as the responsible vehicle, and
controls the first operation execution unit's operation using the key and the second operation execution unit's parcel movement operation.

8. The delivery management device according to claim 7, wherein the first operation execution unit and the second operation execution unit are formed with one or more robot arms.

9. The delivery management device according to claim 1, wherein the processing circuitry receives the delivery request as a request with no designation of a rendezvous spot of the user.

10. A delivery system comprising:
the delivery management device according to claim 1; and
the plurality of vehicles.

11. A delivery system comprising:
the delivery management device according to claim 3; and
the plurality of vehicles.

12. A delivery management method to be executed by a delivery management device including processing circuitry to execute communication with a plurality of vehicles each of which autonomously travels in a previously set area and to output vehicle position information indicating a vehicle present position, and to issue commands to the plurality of vehicles based on map information indicating a map of the area, vehicle information indicating types of the plurality of vehicles, user information that includes information regarding a user terminal outputting user position information indicating a user present position and information regarding a user, and storage space information including a position of a storage space that can be used by the user, the method comprising:
upon receiving a delivery request for delivering a first parcel stored in the storage space locked to the user, selecting one vehicle among the plurality of vehicles as a responsible vehicle based on one or more items of information out of contents of the delivery request, the map information, the vehicle information, the user information and the storage space information and making the responsible vehicle move to the user present position while keeping track of the user in real time;
receiving a key entrustment completion notification, indicating that a key of the storage space has been entrusted to the responsible vehicle, from the responsible vehicle;
making the responsible vehicle move to the storage space and receiving a pickup completion notification, indicating that the first parcel stored in the storage space unlocked by using the key has been loaded onto the responsible vehicle, from the responsible vehicle; and
making the responsible vehicle move to the user present position again and receiving a delivery & key return completion notification, indicating that the first parcel and the key have been taken out from the responsible vehicle, from the responsible vehicle.

13. A delivery management method to be executed by a delivery management device including processing circuitry to execute communication with a plurality of vehicles each of which autonomously travels in a previously set area and to output vehicle position information indicating a vehicle present position, and to issue commands to the plurality of vehicles based on map information indicating a map of the area, vehicle information indicating types of the plurality of vehicles, user information that includes information regarding a user terminal outputting user position information indicating a user present position and information regarding a user, and storage space information including a position of a storage space that can be used by the user, the method comprising:
upon receiving a delivery request for delivering a second parcel picked up from the user to the storage space, selecting one vehicle among the plurality of vehicles as a responsible vehicle based on one or more items of information out of contents of the delivery request, the map information, the vehicle information, the user information and the storage space information and making the responsible vehicle move to the user present position while keeping track of the user in real time;
receiving a key entrustment completion notification indicating that a key of the storage space has been entrusted to the responsible vehicle and a pickup completion notification indicating that the second parcel has been loaded onto the responsible vehicle from the responsible vehicle;
making the responsible vehicle move to the storage space and receiving a delivery completion notification indicating that the second parcel has been stored in the storage space and a locking completion notification indicating that the storage space has been locked by using the key; and
making the responsible vehicle move to the user present position again and receiving a key return completion notification, indicating that the key has been returned to the user, from the responsible vehicle.

14. A non-transitory computer-readable storage medium for storing a delivery management program to be executed by a computer as a delivery management device including processing circuitry to execute communication with a plurality of vehicles each of which autonomously travels in a previously set area and to output vehicle position information indicating a vehicle present position, and to issue commands to the plurality of vehicles based on map information indicating a map of the area, vehicle information indicating types of the plurality of vehicles, user information that includes information regarding a user terminal outputting user position information indicating a user present position and information regarding a user, and storage space information including a position of a storage space that can be used by the user,
wherein the delivery management program causes the computer to execute the delivery management method according to claim 12.

15. A non-transitory computer-readable storage medium for storing a delivery management program to be executed by a computer as a delivery management device including processing circuitry to execute communication with a plurality of vehicles each of which autonomously travels in a previously set area and to output vehicle position information indicating a vehicle present position, and to issue commands to the plurality of vehicles based on map information indicating a map of the area, vehicle information indicating types of the plurality of vehicles, user information that includes information regarding a user terminal outputting user position information indicating a user present position and information regarding a user, and storage space information including a position of a storage space that can be used by the user,
wherein the delivery management program causes the computer to execute the delivery management method according to claim 13.
